(19) United States
(12) Patent Application Publication
(10) Pub. No.: US 2023/0306685 A1
(43) Pub. Date: Sep. 28, 2023

(54) IMAGE PROCESSING METHOD, MODEL TRAINING METHOD, RELATED APPARATUSES, AND PROGRAM PRODUCT

(71) Applicant: Tencent Technology (Shenzhen) Company Limited, Shenzhen (CN)

(72) Inventor: Weibin QIU, Shenzhen (CN)

(21) Appl. No.: 18/205,213

(22) Filed: Jun. 2, 2023

Related U.S. Application Data
(63) Continuation of application No. PCT/CN2022/119348, filed on Sep. 16, 2022.

(30) Foreign Application Priority Data
Nov. 5, 2021 (CN) 202111302904.6

(51) Int. Cl. G06T 17/20; G06T 3/00; G06T 7/90

(52) U.S. Cl. CPC G06T 17/20; G06T 3/0031; G06T 7/90

(57) ABSTRACT

Embodiments of this application disclose an image processing method performed by a computer device. The method includes: constructing a three-dimensional facial mesh corresponding to a target object according to a target image of the target object; transforming the three-dimensional facial mesh into a target UV map, the target UV map carrying position data of vertices on the three-dimensional facial mesh; determining target face creation parameters according to the target UV map; and generating, on the basis of the target face creation parameters, a target virtual facial image corresponding to the target object. The method can make a three-dimensional structure of a virtual facial image generated by face creation comply with a three-dimensional structure of a real face, thereby improving the accuracy and efficiency of the virtual facial image generated by face creation.

### CROSS-REFERENCE TO RELATED APPLICATIONS

This application is a continuation application of PCT Patent Application No. PCT/CN2022/119348, entitled “IMAGE PROCESSING METHOD, MODEL TRAINING METHOD, RELATED APPARATUSES, AND PROGRAM PRODUCT” filed on Sep. 16, 2022, which claims priority to Chinese Patent Application No. 202111302904.6, entitled “IMAGE PROCESSING METHOD, MODEL TRAINING METHOD, RELATED APPARATUSES, AND PROGRAM PRODUCT” filed with China National Intellectual Property Administration on Nov. 5, 2021, all of which is incorporated herein by reference in its entirety.

### FIELD OF THE TECHNOLOGY

This application relates to the technical field of artificial intelligence, and in particular to image processing.

### BACKGROUND OF THE DISCLOSURE

Face creation is a function that supports a user to customize and modify the face of a virtual object. At present, game applications, short video applications, image processing applications, and the like can provide a face creation function for users.

In related technologies, an implementation of the face creation function is mainly achieved by a user. That is, the user adjusts a facial image of a virtual object by manually adjusting face creation parameters until a virtual facial image that meets an actual need is obtained. Usually, the face creation function would involve a large number of controllable points. Correspondingly, there are many face creation parameters that can be adjusted by users. Users often need to spend a long time on adjusting the face creation parameters to obtain a virtual facial image that meets their actual needs. The face creation efficiency is relatively low, and cannot meet application demands of users for quickly generating personalized virtual facial images.

### SUMMARY

Embodiments of this application provide an image processing method, a model training method, related apparatuses, a device, a storage medium, and a program product, which can make a three-dimensional structure of a virtual facial image generated by face creation comply with a three-dimensional structure of a real face, thereby improving the accuracy and efficiency of the virtual facial image generated by face creation.

In view of this, one aspect of this application provides an image processing method, including:
constructing a three-dimensional facial mesh corresponding to a target object according to a target image of the target object;
transforming the three-dimensional facial mesh into a target UV map, the target UV map carrying position data of vertices on the three-dimensional facial mesh;
determining target face creation parameters according to the target UV map; and
generating, on the basis of the target face creation parameters, a target virtual facial image corresponding to the target object.

Still another aspect of this application provides a computer device, including a processor and a memory,
the memory being configured to store a computer program; and
the processor being configured to perform the image processing method described above through executing the computer program.

Yet another aspect of this application provides a non-transitory computer-readable storage medium. The computer-readable storage medium is configured to store a computer program. The computer program, when executed by a processor of a computer device, is used for performing the image processing method in the first aspect.

According to the foregoing technical solutions, it can be learned that the embodiments of this application have the following advantages:

The embodiments of this application provide an image processing method. In a process of predicting, on the basis of a two-dimensional image, face creation parameters corresponding to the face of an object, the method introduces three-dimensional structure information of the face of the object in the two-dimensional image, so that the face creation parameters obtained by prediction can reflect a three-dimensional structure of the face of the object in the two-dimensional image. After the target image including the face of the target object is obtained, the three-dimensional facial mesh corresponding to the target object is constructed according to the target image, and the determined three-dimensional facial mesh can reflect the three-dimensional structure information of the face of the target object in the target image. In order to accurately introduce the three-dimensional structure information of the face of the target object into the process of predicting the face creation parameters, the embodiments of this application cleverly proposes an implementation of using a UV map to carry the three-dimensional structure information, that is, the three-dimensional facial mesh corresponding to the target object is transformed into the corresponding target UV map, and the target UV map is used to carry the position data of the various vertices on the three-dimensional facial mesh. The target face creation parameters corresponding to the target object can be determined according to the target UV map. Thus, the target virtual facial image corresponding to the target object is generated according to the target face creation parameters. Since the target UV map for the prediction of the face creation parameters carries the three-dimensional structure information of the face of the target object, the predicted target face creation parameters can represent the three-dimensional structure of the face of the target object. Correspondingly, the three-dimensional structure of the target virtual facial image generated on the basis of the target face creation parameters can accurately match the three-dimensional structure of the face of the target object, so that the problem of depth distortion is avoided, and the accuracy and efficiency of the generated virtual facial image are improved.

### BRIEF DESCRIPTION OF THE DRAWINGS

FIG. 1 is a schematic diagram of an application scenario of an image processing method according to an embodiment of this application.

FIG. 2 is a flowchart of an image processing method according to an embodiment of this application.

FIG. 3 is a schematic diagram of an interface of a face creation function according to an embodiment of this application.

FIG. 4 is a schematic diagram of modeling parameters of a parameterized model of a three-dimensional face according to an embodiment of this application.

FIG. 5 shows three UV maps according to an embodiment of this application.

FIG. 6 is a schematic diagram of implementation of mapping a patch on a three-dimensional facial mesh to a basic UV map according to an embodiment of this application.

FIG. 7 is a schematic diagram of another interface of a face creation function according to an embodiment of this application.

FIG. 8 is a flowchart of a model training method for a three-dimensional face reconstruction model according to an embodiment of this application.

FIG. 9 is a schematic diagram of a training architecture of a three-dimensional face reconstruction model according to an embodiment of this application.

FIG. 10 is a flowchart of a training method for a face creation parameter prediction model according to an embodiment of this application.

FIG. 11 is a schematic diagram of a training architecture of a face creation parameter prediction model according to an embodiment of this application.

FIG. 12 is a schematic diagram of a working principle of a three-dimensional facial mesh prediction model according to an embodiment of this application.

FIG. 13 is a flowchart of experimental results of an image processing method according to an embodiment of this application.

FIG. 14 is a schematic structural diagram of an image processing apparatus according to an embodiment of this application.

FIG. 15 is a schematic structural diagram of a model training apparatus according to an embodiment of this application.

FIG. 16 is a schematic structural diagram of a terminal device according to an embodiment of this application.

FIG. 17 is a schematic structural diagram of a server according to an embodiment of this application.

### DESCRIPTION OF EMBODIMENTS

In order to enable a person skilled in the art to better under the solutions of this application, the following clearly and completely describes the technical solutions of the embodiments of this application with reference to the accompanying drawings in the embodiments of this application. Apparently, the described embodiments are merely some rather than all of the embodiments of this application. Based on the embodiments in this application, all other embodiments obtained by those of ordinary skill in the art without creative work all fall within the protection scope of this application.

The terms such as “first”, “second”, “third”, “fourth”, and the like (if any) in the specification and claims of this application and in the above accompanying drawings are used for distinguishing similar objects and not necessarily used for describing any particular order or sequence. It is to be understood that such used data is interchangeable where appropriate so that the embodiments of this application described here can be implemented in an order other than those illustrated or described here. Moreover, the terms “include”, “has”, and any variations thereof are intended to cover a non-exclusive inclusion. For example, a process, a method, a system, a product, or a device that includes a series of steps or units is not necessarily limited to those steps or units expressly listed, but may include other steps or units not expressly listed or inherent to these processes, methods, products or devices.

The solutions provided in the embodiments of this application involve a computer vision technology in artificial intelligence, and will be explained through the following embodiments:

The efficiency of manual face creation in related technologies is extremely low, and there are also ways to automatically create faces through photos. That is, a user uploads a face image, and a background system automatically predicts face creation parameters on the basis of the face image. Then, a face creation system is used to generate a virtual facial image similar to the face image on the basis of the face creation parameters. Although this manner has relatively high face creation efficiency, its implementation effect in a three-dimensional face creation scene is poor. Specifically, when the face creation parameters are predicted using this manner, end-to-end prediction is directly performed on the basis of a two-dimensional face image. The face creation parameters obtained in this way lack three-dimensional spatial information. Correspondingly, the virtual facial image generated on the basis of the face creation parameters often has a severe depth distortion problem, that is, a three-dimensional structure of the generated virtual facial image does not match a three-dimensional structure of a real face. Depth information of facial features on the virtual facial image is extremely inaccurate.

In order to solve the problem in the related technologies of low face creation efficiency and the problem that the virtual facial image generated by the face creation function has a depth distortion and does not match the three-dimensional structure of the real object face, the embodiments of this application provide an image processing method.

In the image processing method, a target image including the face of a target object is first obtained. Then, a three-dimensional facial mesh corresponding to the target object is constructed according to the target image. Next, the three-dimensional facial mesh corresponding to the target object is transformed into a target UV map, the target UV map being used for carrying position data of various vertices on the three-dimensional facial mesh corresponding to the target object. Thus, target face creation parameters are determined on the basis of the target UV map. Finally, a target virtual facial image corresponding to the target object is generated on the basis of the target face creation parameters.

In the above image processing method, the three-dimensional facial mesh corresponding to the target object is constructed according to the target image, so that three-dimensional structure information of the face of the target object in the target image is determined. Considering a high difficulty in directly predicting the face creation parameters on the basis of the three-dimensional facial mesh, this embodiment of this application cleverly proposes an implementation of using a UV map to carry the three-dimensional structure information, that is, using the target UV map to carry the position data of the various vertices in the three-dimensional facial mesh corresponding to the target object, thereby determining the target face creation parameters corresponding to the face of the target object according to the target UV map. In this way, prediction of the face creation parameters based on a three-dimensional grid structure is transformed into prediction of the face creation parameters based on a two-dimensional UV map, which reduces the difficulty of predicting the face creation parameters and improving the accuracy of predicting the face creation parameters, so that the predicted target face creation parameters can accurately represent the three-dimensional structure of the face of the target object. Correspondingly, the three-dimensional structure of the target virtual facial image generated on the basis of the target face creation parameters can accurately match the three-dimensional structure of the face of the target object, so that the problem of deep distortion is avoided, and the accuracy of the generated virtual facial image is improved.

It is understood that the image processing method provided in this embodiment of this application can be performed by a computer device with an image processing capability. The computer device may be a terminal device or a server. The terminal device may specifically be a computer, a smartphone, a tablet, a Personal Digital Assistant (PDA), and the like. The server may specifically be an application server or a Web server. In actual deployment, it may be an independent server or a cluster server or cloud server composed of a plurality of physical servers. Image data (such as the image itself, the three-dimensional facial mesh, the face creation parameters, and the virtual facial image) involved in this embodiment of this application can be saved on a blockchain.

In order to facilitate the understanding of the image processing method provided in this embodiment of this application, the following will exemplarily describe an application scenario of the image processing method by taking a server serving as an executive body of the image processing method as an example.

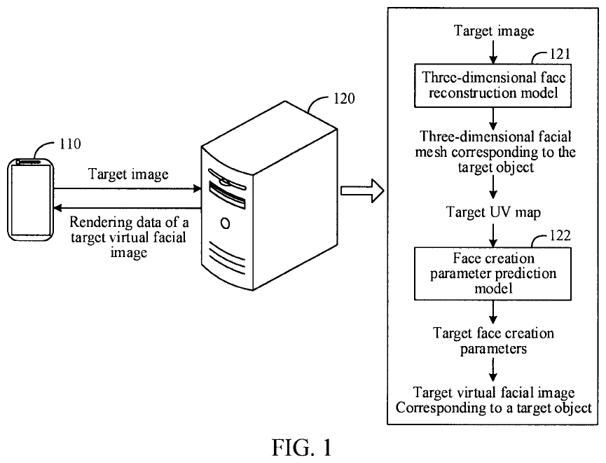

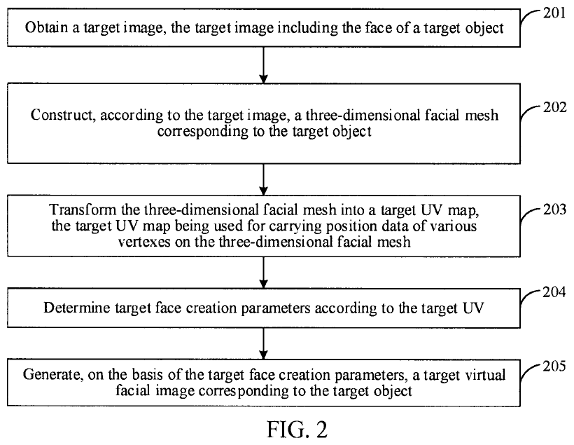

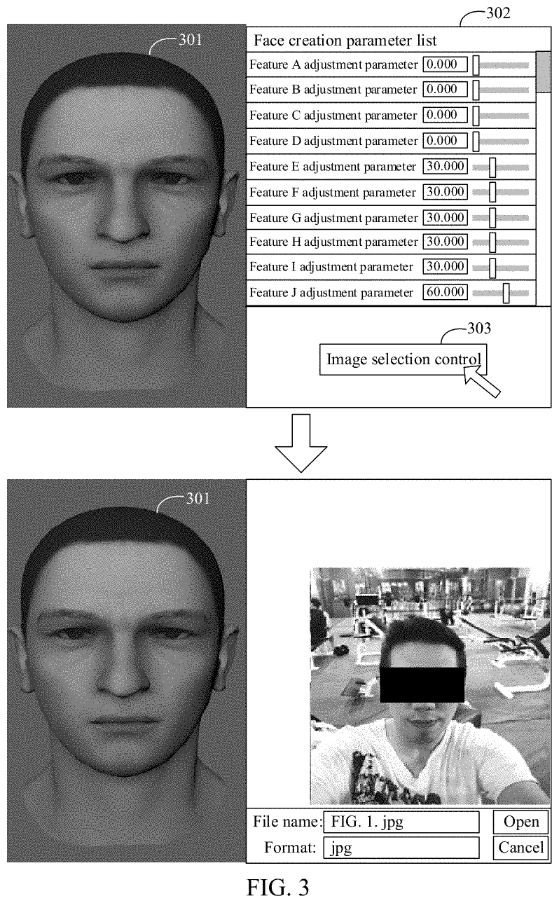

Referring to FIG. 1, FIG. 1 is a schematic diagram of an application scenario of an image processing method according to an embodiment of this application. As shown in FIG. 1, the application scenario includes a terminal device 110 and a server 120. The terminal device 110 and the server 120 may communicate with each other through a network. The terminal device 110 runs a target application that supports a face creation function, such as a game application, a short video application, an image processing application, and the like. The server 120 is a background server of the target application, and is configured to implement the image processing method provided in this embodiment of this application to support achieving the face creation function in the target application.

In practical applications, a user can upload a target image including the face of a target object to the server 120 through the face creation function provided by the target application run on the terminal device 110. For example, when the user uses the face creation function provided by the target application, an image selection control provided by the face creation function may be used to select a target image including the face of a target object locally on the terminal device 110. After detecting that the user has confirmed completion of an image selection operation, the terminal device 110 may transmit the selected target image to the server 120 through the network.

After receiving the target image transmitted by the terminal device 110, the server 120 may extract, from the target image, three-dimensional structure information related to the face of the target object. For example, the server 120 may determine three-dimensional face reconstruction parameters corresponding to the target object according to the target image through a three-dimensional face reconstruction model 121, and construct a three-dimensional facial mesh corresponding to the target object on the basis of the three-dimensional face reconstruction parameters. It is understood that the three-dimensional facial mesh corresponding to the target object can represent a three-dimensional structure of the face of the target object.

Then, the server may transform the three-dimensional facial mesh corresponding to the target object into a target UV map, so as to use the target UV map to carry position data of various vertices in the three-dimensional facial mesh. Considering a high difficulty in directly predicting the face creation parameters on the basis of three-dimensional structure data in practical applications, this embodiment of this application proposes a manner of transforming three-dimensional map structure data into a two-dimensional UV map, so that on the one hand, the difficulty in predicting the face creation parameters can be lowered, and on the other hand, it can be ensured that the three-dimensional structure information of the face of the target object is effectively introduced in the prediction process of the face creation parameters.

Thus, the server may determine, according to the target UV map, target face creation parameters corresponding to the target object. For example, the server may determine the target face creation parameters corresponding to the target object according to the target UV map through a face creation parameter prediction model 122. Furthermore, a face creation system in a background of the target application is used to generate, on the basis of the target face creation parameters, a target virtual facial image corresponding to the target object. The target virtual facial image is similar to the face of the target object, and the three-dimensional structure of the target virtual facial image matches the three-dimensional structure of the face of the target object. Depth information of facial features on the target virtual facial image is accurate. Correspondingly, the server 120 may transmit rendering data of the target virtual facial image to terminal device 110, so that terminal device 110 may render and display the target virtual facial image on the basis of the rendering data.

It is understood that the application scenario shown in FIG. 1 is only an example. In practical applications, the image processing method provided in this embodiment of this application can also be applied to other scenarios. For example, the image processing method provided in this embodiment of this application may be independently completed by the terminal device 110, that is, the terminal device 110 independently generates, on the basis of the target image selected by the user, a target virtual facial image corresponding to the target object in the target image. For another example, the image processing method provided in this embodiment of this application may also be completed by the terminal device 110 and the server 120 synergistically, that is, the server 120 determines, on the basis of the target image uploaded by the terminal device 110, the target face creation parameters corresponding to the target object in the target image, and returns the target face creation parameters to the terminal device 110. Thus, the terminal device 110 generates, on the basis of the target face creation parameters, the target virtual facial image corresponding to the target object. There are no limitations on the application scenario applicable to the image processing method provided in this embodiment of this application.

The following is a detailed introduction to the image processing method provided in this application through method embodiments.

Referring to FIG. 2, FIG. 2 is a flowchart of an image processing method according to an embodiment of this application. To facilitate description, the following embodiments are still described by taking a server serving as an executive body of the image processing method for example. As shown in FIG. 2, the image processing method includes the following steps:

Step 201: Obtain a target image. The target image includes the face of a target object.

In practical applications, before performing automatic face creation, the server first obtains the target image on which the automatic face creation depends. The target image includes the clear and complete face of the target object.

In one possible implementation, the server may obtain the aforementioned target image from a terminal device. Specifically, when a target application with a face creation function is run on the terminal device, a user may select the target image through the face creation function in the target application, and then transmit the target image selected by the user to the server through the terminal device.

For example, FIG. 3 is a schematic diagram of an interface of a face creation function according to an embodiment of this application. When the user has not yet selected a target image, the interface of the face creation function may display a basic virtual facial image 301 and a face creation parameter list 302 corresponding to the basic virtual facial image 301. The face creation parameter list 302 includes various face creation parameters (displayed in a parameter display bar) corresponding to the basic virtual facial image. At this point, the user may change the basic virtual facial image 301 by adjusting face creation parameters of feature A to feature J in the face creation parameter list 302 (for example, directly adjusting the parameters in the parameter display bar or adjusting the parameters by dragging a parameter adjustment slider). The above interface of the face creation function also includes an image selection control 303, and the user may trigger execution of a target image selection operation by clicking the image selection control 303. For example, after clicking the image selection control 303, the user may select, from a local folder of the terminal device, an image including the face as a target image. After detecting that the user has completed the target image selection operation, the terminal device may correspondingly transmit the target image selected by the user to the server through the network.

It is understood that in practical applications, the above interface of the face creation function may also include an image capture control, and the user may capture a target image in real time through the image capture control, so that the terminal device may transmit the captured target image to the server. This application does not impose any restrictions on the manner that the terminal device provides the target image.

In another possible implementation, the server may also obtain the target image from a database. Specifically, the database stores a large number of images including the faces of objects, and the server may invoke any image from the database as the target image.

It is understood that when the executive body of the image processing method provided in this embodiment of this application is the terminal device, the terminal device may obtain a target image from locally stored images in response to an operation of a user, or may capture an image in real time as a target image in response to an operation of a user. This application does not make any limitation on how the server and the terminal device obtain the target image.

Step 202: Construct, according to the target image, a three-dimensional facial mesh corresponding to the target object.

In one possible implementation, after obtaining the target image, the server inputs the target image into a pre-trained three-dimensional face reconstruction model. The three-dimensional face reconstruction model may correspondingly determine, by analyzing the inputted target image, three-dimensional face reconstruction parameters corresponding to the target object in the target image, and may construct a three-dimensional facial mesh (3D mesh) corresponding to the target object on the basis of the three-dimensional face reconstruction parameters. The above three-dimensional face reconstruction model is used for reconstructing a model of a three-dimensional facial structure of the target object in the two-dimensional image according to the two-dimensional image. The above three-dimensional face reconstruction parameters are intermediate processing parameters of the three-dimensional face reconstruction model, and are required by the reconstruction of the three-dimensional facial structure of the object. The above three-dimensional facial mesh may represent the three-dimensional facial structure of the target object. The three-dimensional facial mesh is usually composed of several triangular patches. Vertices of the triangular patches here are vertices on the three-dimensional facial mesh. That is, three vertices on the three-dimensional facial mesh are connected to obtain one triangular patch.

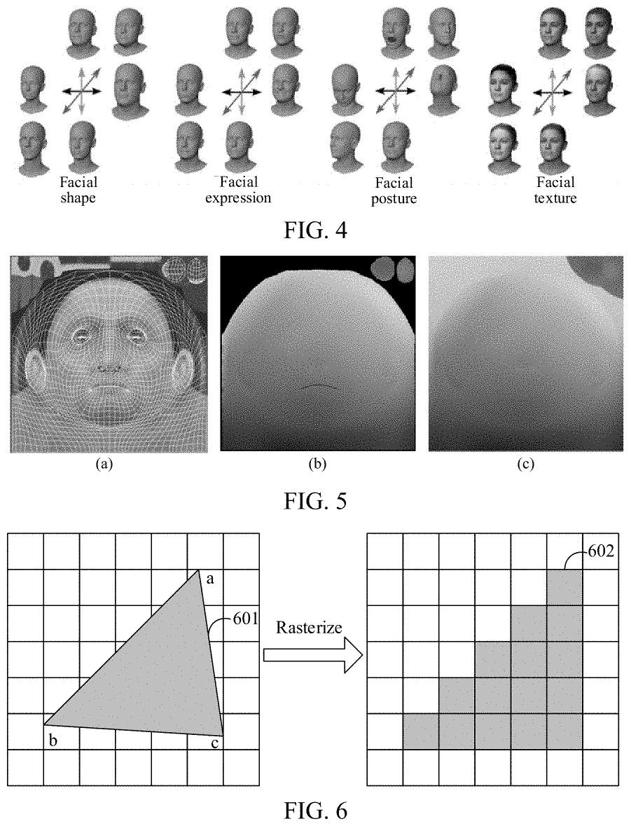

For example, this embodiment of this application may use a 3D Morphable model (3DMM) as the aforementioned three-dimensional face reconstruction model. In the field of three-dimensional face reconstruction, by performing principal component analysis (PCA) on 3D scanned facial data, it is found that a three-dimensional face can be represented as a parameterized morphable model. Based on this, three-dimensional face reconstruction can be transformed into prediction of parameters in a parameterized facial model. As shown in FIG. 4, parameterized models of three-dimensional faces usually include modeling a facial shape, a facial expression a facial posture, and facial textures. The 3DMM works on the basis of the above working principles.

In specific implementation, after the target image is inputted into 3DMM, the 3DMM may correspondingly analyze the face of the target object in the target image, thereby determining the three-dimensional face reconstruction parameters corresponding to the target image. The determined three-dimensional face reconstruction parameters may include, for example, a facial shape parameter, a facial expression parameter, a facial posture parameter, a facial texture parameter, and a spherical harmonic illumination coefficient. Furthermore, the 3DMM may reconstruct the three-dimensional facial mesh corresponding to the target object on the basis of the determined three-dimensional face reconstruction parameters.

It is noted that, Considering that many face creation functions in practical applications focus on adjusting the form of the basic virtual facial image, making shapes of the five sense organs on the virtual facial image and an expression presented by the virtual facial image close to the target object in the target image, instead of considering making texture information such as a skin color of the virtual facial image close to the target object in the target image, the texture information of the basic virtual facial image is usually selected to be directly maintained. Based on this, after using the 3DMM to determine the three-dimensional face reconstruction parameters corresponding to the target object in the target image, this embodiment of this application may discard the facial texture parameter. The three-dimensional facial mesh corresponding to the target object is directly constructed on the basis of default facial texture data. Or, in this embodiment of this application, when determining the three-dimensional face reconstruction parameters through the 3DMM, facial texture data may not be directly predicted. In this way, the amount of data that needs to be processed in a subsequent data processing process is reduced, and a data processing load in the subsequent data processing process is alleviated.

It is understood that in practical applications, in addition to using the 3DMM as the three-dimensional face reconstruction model, other models that can reconstruct a three-dimensional structure of the face of the object on the basis of the two-dimensional image may also be used as the three-dimensional face reconstruction model in this embodiment of this application. This application does not specifically make limitations on the three-dimensional face reconstruction model.

It is understood that in practical applications, the server can not only use the three-dimensional face reconstruction model to determine the three-dimensional face reconstruction parameters corresponding to the target object and construct the three-dimensional facial mesh corresponding to the target object, but also use other manners to determine the three-dimensional face reconstruction parameters corresponding to the target object and construct the three-dimensional facial mesh corresponding to the target object. This application does not impose any limitations on this.

Step 203: Transform the three-dimensional facial mesh into a target UV map. The target UV map is used for carrying position data of various vertices on the three-dimensional facial mesh.

After constructing the three-dimensional facial mesh corresponding to the target object in the target image, the server may transform the three-dimensional facial mesh corresponding to the target object into a target UV map, the target UV map being used for carrying the position data of the various vertices on the three-dimensional facial mesh corresponding to the target object.

It is noted that, in practical applications, a UV map is a planar representation of a surface of a three-dimensional model used for packaging textures. U and V represent a horizontal axis and a vertical axis in a two-dimensional space respectively. Pixel points in the UV map are used for carrying texture data of the mesh vertices in on the three-dimensional model. That is, color channels of the pixel points in the UV map, such as Red Green Blue (RGB) channels, are used for carrying the texture data (namely, RGB values) of the mesh vertices corresponding to the pixel points on the three-dimensional model. FIG. 5(a) shows a traditional UV map. This embodiment of this application does not limit a specific type of a color channel. For example, the color channel may be an RGB channel, or other types of color channels, such as a HEX channel and an HSL channel.

In this embodiment of this application, the UV map is no longer used to carry the texture data of the three-dimensional facial mesh, but innovatively used to carry the position data of the mesh vertices in the three-dimensional facial mesh. The reason for this processing is that if face creation parameters are directly predicted on the basis of the three-dimensional facial mesh, it is necessary to input the three-dimensional facial mesh of a graph structure into a face creation parameter prediction model. However, it is usually hard for a commonly used convolutional neural network to directly process data of the graph structure at present. To solve this problem, this embodiment of this application proposes a solution of transforming the three-dimensional facial mesh into a two-dimensional UV map. Thus, three-dimensional facial structure information is effectively introduced into a prediction process of the face creation parameters.

Specifically, when the three-dimensional facial mesh corresponding to the target object is transformed into the target UV map, the server may determine color channel values of the pixel points in the basic UV map on the basis of a correspondence relationship between the vertices on the three-dimensional facial mesh and pixel points in a basic UV map and the position data of the various vertices on the three-dimensional facial mesh corresponding to the target object; and determine, on the basis of the color channel values of the pixel points in the basic UV map, the target UV map corresponding to the face of the target object.

It is noted that, the basic UV map is an initial UV map that has not been endowed with structure information of the three-dimensional facial mesh, where the RGB channel values of the various pixel points are all initial channel values. For example, the RGB channel values of the various pixel points may all be 0. The target UV map is a UV map obtained by transforming the basic UV map on the basis of the structure information of the three-dimensional facial mesh. The RGB channel values of the pixel points are determined on the basis of the position data of the vertices on the three-dimensional facial mesh.

Generally, three-dimensional facial meshes with the same topology may share the same UV spreading form, that is, the vertices on the three-dimensional facial mesh have a fixed correspondence relationship with the pixel points in the basic UV map. Based on the correspondence relationship, the server may correspondingly determine the corresponding pixel points, in the basic UV map, of the various vertices on the three-dimensional facial mesh corresponding to the target object, and then use the RGB channels of the pixel points to carry xyz coordinates of the corresponding vertices. After the RGB channel values of the pixel points, in the basic UV map, separately corresponding to the various vertices on the three-dimensional facial mesh are determined, RGB channel values of pixel points, in the basic UV map, that do not correspond to the vertices on the three-dimensional facial mesh can be further determined on the basis of the RGB channel values of these pixel points, thereby transforming the basic UV map into the target UV map.

Specifically, during the transforming the basic UV map into the target UV map, the server needs to first use the correspondence relationship between the vertices on the three-dimensional facial mesh and the basic UV map to determine the pixel points, in the basic UV map, separately corresponding to the various vertices on the three-dimensional facial mesh; then, normalize the xyz coordinate of each vertex on the three-dimensional facial mesh, and assign the normalized xyz coordinates to the RGB channels of the corresponding pixel points; and determine the RGB channel values of the pixel points, in the basic UV map, that have the correspondence relationship with the various vertices on the three-dimensional facial mesh. Thus, the RGB channel values of other pixel points, in the basic UV map, that do not have a correspondence relationship with the vertices on the three-dimensional facial mesh are correspondingly determined on the basis of the RGB channel values of these pixel points, in the basic UV map, that have the correspondence relationship with the vertices on the three-dimensional facial mesh. For example, the RGB channel values of the pixel points, in the basic UV map, that have the correspondence relationship with the vertices on the three-dimensional facial mesh are interpolated to determine the RGB channel values of other pixel points that do not have correspondence relationship. In this way, after the assignment of the RGB channels of the various pixel points in the basic UV map, the corresponding target UV map can be obtained, achieving the transformation from the basic UV map into the target UV map.

It is noted that, Before using the UV map to carry the xyz coordinate values of the vertices on the three-dimensional facial mesh corresponding to the target object, in order to adapt to the value range of the RGB channels in the UV map, the server needs to first normalize the xyz coordinate values of the vertices on the three-dimensional facial mesh corresponding to the target object, so that the xyz coordinate values of the vertices on the three-dimensional facial mesh are limited to the range of [0, 1].

Further, the server may determine the color channel values of the pixel points in the target UV map by: for each patch on the three-dimensional facial mesh corresponding to the target object, determining, on the basis of the correspondence relationship, pixel points separately corresponding to the vertices in the patch from the basic UV map, and determining a color channel value of the corresponding pixel point according to the position data of each vertex; determining a coverage region of the patch in the basic UV map according to the pixel points separately corresponding to the vertices in the patch, and rasterizing the coverage region; and interpolating, on the basis of a quantity of pixel points included in the rasterized coverage region, the color channel values of the pixel points separately corresponding to the vertices in the patch, and taking the interpolated color channel values as color channel values of the pixel points in the rasterized coverage region.

For example, FIG. 6 is a schematic diagram of implementation of mapping a patch on a three-dimensional facial mesh to a basic UV map. As shown in FIG. 6, during mapping the patch on the three-dimensional facial mesh into the basic UV map, the server may first determine the pixel points, in the basic UP map, separately corresponding to the various vertices of the patch on the basis of the correspondence relationship between the vertices on the three-dimensional facial mesh and the pixel points in the basic UV map, for example, determine that the pixel points, in the basic UV map, separately corresponding to the various vertices of the patch are respectively a pixel point a, a pixel point b, and a pixel point c. Then, the server may write the xyz coordinate values of the various vertices on the normalized patch into the RGB channels of the pixel points corresponding to the vertices. After the server determines the pixel points, in the basic UV map, separately corresponding to the various vertices of the patch, the pixel points separately corresponding to the various vertices may be connected to obtain the coverage region of the patch in the basic UV map, for example, a region 601 in FIG. 6. Furthermore, the server may rasterize the coverage region 601 to obtain the rasterized coverage region, for example, a region 602 in FIG. 6.

During the rasterization, the server may determine the various pixel points involved in the coverage region 601, and then use the regions separately corresponding to these pixel points to form the rasterized coverage region 602. Or, for each pixel point involved in the coverage region 601, the server may also determine an overlap area of the corresponding region and the coverage region 601, and determine whether a proportion of the overlap area within the region corresponding to the pixel point exceeds a preset proportion threshold. If so, the pixel point is used as a reference pixel point. Finally, the rasterized coverage region 602 is formed by utilizing the regions corresponding to all the reference pixel points.

For the rasterized coverage region, the server may interpolate, on the basis of a quantity of pixel points included in the rasterized coverage region, the RGB channel values of the pixel points separately corresponding to the various vertices in the patch, and assign the interpolated RGB channel values to the corresponding pixel points in the rasterized coverage region. As shown in FIG. 6, for the rasterized coverage region 602, the server may interpolate the RGB channel values of the pixel points a, b, and c on the basis of five horizontally covered pixel points and five longitudinally covered pixel points, and correspondingly assign the RGB channel values obtained after the interpolation to the corresponding pixel points in the region 602.

In this way, the various patches on the three-dimensional facial mesh corresponding to the target object are mapped in the above way. The pixel points in the coverage regions corresponding to the various patches in the basic UV map are used to carry the position data of the vertices on the three-dimensional facial mesh, achieving the transformation of the three-dimensional facial structure into the two-dimensional UV map, ensuring that the two-dimensional UV map can effectively carry the three-dimensional structure information corresponding to the three-dimensional facial mesh. Thus, it is beneficial to introduce the three-dimensional structure information corresponding to the three-dimensional facial mesh in the prediction process of the face creation parameters. After the above processing, the UV map shown in FIG. 5(b) is obtained, which carries the three-dimensional structure information of the three-dimensional facial mesh corresponding to the target object.

In practical applications, some regions in the UV map obtained through the above processing may appear black correspondingly due to the absence of corresponding vertices in the three-dimensional facial mesh and the absence of any position information. In order to avoid the influence on the accuracy of a prediction result of the face creation parameters by excessive attentions paid by a subsequent face creation parameter prediction model to this part of the regions, this embodiment of this application proposes a manner for mending the above UV map.

That is, the server may first determine, using the above manner, the color channel values of the various pixel points in a target mapping region in the basic UV map according to the position data of the various vertices on the three-dimensional facial mesh corresponding to the target object, to transform the basic UV map into a reference UV map. The target mapping region here is composed of the coverage regions, in the basic UV map, of the various patches on the three-dimensional facial mesh corresponding to the target object. When the above target mapping region mentioned above does not fully cover the basic UV map, the server may mend the reference UV map to transform the reference UV map into the target UV map.

For example, after the server completes the assignment of the color channel values of the pixel points in the coverage regions, in the basic UV map, corresponding to the various patches on the three-dimensional facial mesh, that is, after the server completes the assignment of the color channel values for the various pixel points in the target mapping region, it can be determined that the operation of transforming the basic UV map into the reference UV map is completed. At this point, if it is detected that there is an unassigned region (namely, a black region) in the reference UV map, the server may mend the reference UV map, thereby transforming the reference UV map into the target UV map. That is, if the server detects that there is an unassigned region in the reference UV map, the server may invoke an image mending function inpaint in OpenCV, and use the image mending function inpaint to mend the reference UV map, so that the unassigned region in the reference UV map is smoothly transitioned. If no unassigned region is detected in the reference UV map, the reference UV map may be directly used as the target UV map.

In this way, the reference UV map with an unassigned region is mended, so that the unassigned region in the reference UV map can be smoothly transitioned, thereby avoiding the influence on the accuracy of the prediction result of the face creation parameters by excessive attentions paid by the subsequent face creation parameter prediction model to this unassigned region. A UV map shown in FIG. 5(c) is the UV map obtained through the above mending.

Step 204: Determine target face creation parameters according to the target UV map.

After obtaining the target UV map used for carrying the three-dimensional structure information of the face of the target object, the server may transform the three-dimensional structure information corresponding to the three-dimensional facial mesh effectively carried by the target UV map into the target face creation parameters.

For example, the target UV map may be inputted into a pre-trained face creation parameter prediction model. The face creation parameter prediction model may correspondingly output, by analyzing the RGB channel values of the pixel points in the inputted target UV map, the target face creation parameters corresponding to the face of the target object. It is noted that, the face creation parameter prediction model is a pre-trained model used for predicting face creation parameters according to the two-dimensional UV map. The target face creation parameters are parameters required by constructing a virtual facial image that matches the face of the target object. The target face creation parameters may be specifically expressed as slider parameters.

It is understood that the face creation parameter prediction model in this embodiment of this application may specifically be a residual neural network (ResNet) model, such as ResNet-18. Of course, in practical applications, other model structures can also be used as the face creation parameter prediction model. This application does not impose any limitations on the model structure of the face creation parameter prediction model used.

It is understood that in practical applications, the server can not only use the face creation parameter prediction model to determine, according to the target UV map, the face creation parameters corresponding to the target object, but also use other manners to determine the target face creation parameters corresponding to the target object. This application does not impose any limitations on this.

Step 205: Generate, on the basis of the target face creation parameters, a target virtual facial image corresponding to the target object.

After obtaining the predicted target face creation parameters according to the target UV map, the server may use a target face creation system to adjust a basic virtual facial image according to the target face creation parameters, thereby obtaining the target virtual facial image that matches the face of the target object.

When the target image obtained by the server is an image uploaded by the user using the target application with the face creation function on the terminal device, the server may transmit rendering data of the target virtual facial image to the terminal device, so that the terminal device renders and displays the target virtual facial image. Or, when the target face creation system is included in the target application, the server may transmit the predicted target face creation parameters to the terminal device, so that the terminal device uses the target face creation system in the target application to generate the target virtual facial image according to the target face creation parameters.

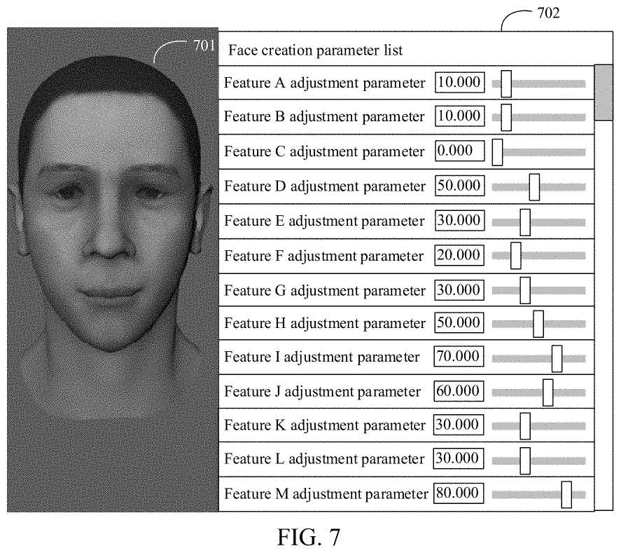

FIG. 7 is a schematic diagram of another interface of a face creation function according to an embodiment of this application. A target virtual facial image 701 corresponding to the face of the target object and a face creation parameter list 702 corresponding to the target virtual facial image 701 can be displayed in the interface of the face creation function. The face creation parameter list 702 includes various target face creation parameters determined by step 204. If the user still needs to modify the target virtual facial image 701, the user can adjust the face creation parameters in the face creation parameter list 702 (for example, directly adjusting parameters in a parameter display bar, or adjusting parameters by dragging a parameter adjustment slider) to adjust the target virtual facial image 701.

In the above image processing method, the three-dimensional facial mesh corresponding to the target object is constructed according to the target image, so that three-dimensional structure information of the face of the target object in the target image is determined. Considering a high difficulty in directly predicting the face creation parameters on the basis of the three-dimensional facial mesh, this embodiment of this application cleverly proposes an implementation of using a UV map to carry the three-dimensional structure information, that is, using the target UV map to carry the position data of the various vertices in the three-dimensional facial mesh corresponding to the target object, thereby determining the target face creation parameters corresponding to the face of the target object according to the target UV map. In this way, prediction of the face creation parameters based on a three-dimensional grid structure is transformed into prediction of the face creation parameters based on a two-dimensional UV map, which reduces the difficulty of predicting the face creation parameters and improving the accuracy of predicting the face creation parameters, so that the predicted target face creation parameters can accurately represent the three-dimensional structure of the face of the target object. Correspondingly, the three-dimensional structure of the target virtual facial image generated on the basis of the target face creation parameters can accurately match the three-dimensional structure of the face of the target object, so that the problem of deep distortion is avoided, and the accuracy and efficiency of the generated virtual facial image are improved.

For the three-dimensional face reconstruction model used in step 202 of the embodiment shown in FIG. 2, this embodiment of this application further proposes a self-supervised training manner for the three-dimensional face reconstruction model.

In theory, if a large number of training images and three-dimensional face reconstruction parameters corresponding thereto are given, a model for predicting three-dimensional face reconstruction parameters according to an image can be trained by using supervised learning. However, research shows that this training manner has obvious defects. On the one hand, it is difficult to obtain a large number of training images including faces and three-dimensional face reconstruction parameters corresponding thereto. Extremely high costs are required to obtain training samples. On the other hand, generally, an existing three-dimensional reconstruction algorithm with better performance needs to be used to calculate the three-dimensional face reconstruction parameters corresponding to the training images, and the three-dimensional face reconstruction parameters are used as training samples of the supervised learning, which will limit the accuracy of the to-be-trained three-dimensional face reconstruction model to the accuracy of the existing model that produces the training samples. In order to address the aforementioned defects, this embodiment of this application proposes a following training method for a three-dimensional face reconstruction model.

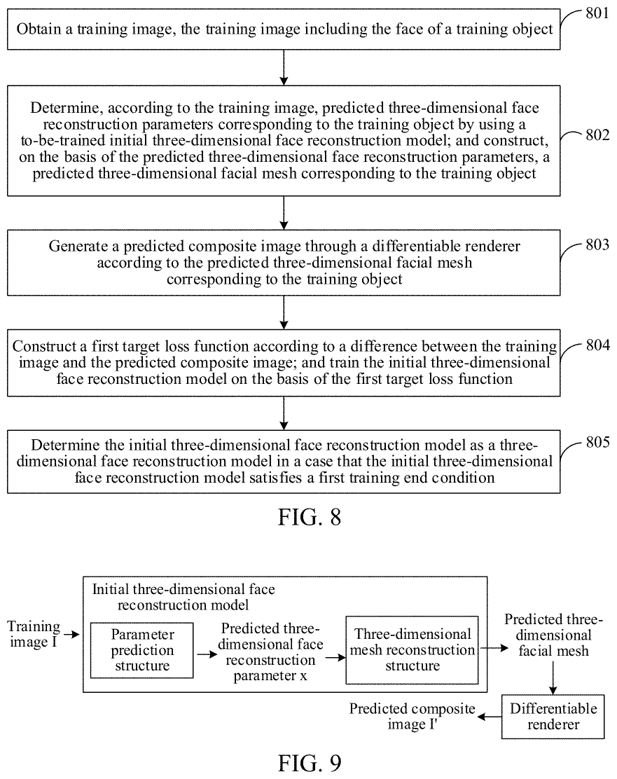

Referring to FIG. 8, FIG. 8 is a flowchart of a model training method for a three-dimensional face reconstruction model according to an embodiment of this application. To facilitate description, the following embodiments will be introduced by taking a server serving as an executive body of the model training method as an example. It is understood that the model training method may also be performed by other computer devices (such as a terminal device) in practical applications. As shown in FIG. 8, the model training method includes the following steps:

Step 801: Obtain a training image, the training image including the face of a training object.

Before training a three-dimensional face reconstruction model, the server needs to first obtain training samples used for training the three-dimensional face reconstruction model, that is, obtain a large number of training images. Since the trained three-dimensional face reconstruction model is used for reconstructing a three-dimensional structure of the face, the obtained training image includes the face of the training object, and the face in the training image needs to be as clear and complete as possible.

Step 802: Determine, according to the training image, predicted three-dimensional face reconstruction parameters corresponding to the training object by using a to-be-trained initial three-dimensional face reconstruction model; and construct, on the basis of the predicted three-dimensional face reconstruction parameters, a predicted three-dimensional facial mesh corresponding to the training object.

After obtaining the training image, the server may train the initial three-dimensional face reconstruction model on the basis of the obtained training image. The initial three-dimensional face reconstruction model is a training basis for the three-dimensional face reconstruction model in the embodiment shown in FIG. 2. The structure of the initial three-dimensional face reconstruction model is the same as that of the three-dimensional face reconstruction model in the embodiment shown in FIG. 2, but model parameters of the initial three-dimensional face reconstruction model are obtained by initialization.

During the training of the initial three-dimensional face reconstruction model, the server may input the training image into the initial three-dimensional face reconstruction model. The initial three-dimensional face reconstruction model may correspondingly determine the predicted three-dimensional face reconstruction parameters corresponding to the training object in the training image, and construct, on the basis of the predicted three-dimensional face reconstruction parameters, the predicted three-dimensional facial mesh corresponding to the training object.

For example, the initial three-dimensional face reconstruction model may include a parameter prediction structure and a three-dimensional mesh reconstruction structure. The parameter prediction structure may be specifically implemented using ResNet-50. Assuming that a parameterized facial model is represented by a total of 239 parameters (including 80 parameters for a facial shape, 64 parameters for a facial expression, 80 parameters for a facial texture, 6 parameters for a facial posture, and 9 parameters for a spherical harmonic illumination coefficient). In this case, the last fully connected layer of the ResNet-50 may be replaced with 239 neurons.

FIG. 9 is a schematic diagram of a training architecture of a three-dimensional face reconstruction model according to an embodiment of this application. As shown in FIG. 9, after the server inputs a training image I into an initial three-dimensional face reconstruction model, a parameter prediction structure ResNet-50 in the initial three-dimensional face reconstruction model may correspondingly predict a 239-dimensional predicted three-dimensional face reconstruction parameter x, and then a three-dimensional mesh reconstruction structure in the initial three-dimensional face reconstruction model may construct a corresponding predicted three-dimensional facial mesh on the basis of the 239 dimensional three-dimensional face reconstruction parameter x.

Step 803: Generate a predicted composite image through a differentiable renderer according to the predicted three-dimensional facial mesh corresponding to the training object.

After constructing the predicted three-dimensional facial mesh corresponding to the training object in the training image through the initial three-dimensional face reconstruction model, the server may further use the differentiable renderer to generate the two-dimensional predicted composite image according to the predicted three-dimensional facial mesh corresponding to the training object. It is noted that, the differentiable renderer is configured to approximate a traditional rendering process as a differentiable process, including a rendering pipeline that can succeed in differentiation. In a gradient backhaul process of deep learning, the differentiable renderer may play a significant role, that is, the use of the differentiable renderer is beneficial to achieving gradient backhaul in the model training process.

As shown in FIG. 9, after generating the predicted three-dimensional facial mesh through the initial three-dimensional face reconstruction model, the server may use the differentiable renderer to render the predicted three-dimensional facial mesh to convert the predicted three-dimensional facial mesh into a two-dimensional predicted composite image I′. During the training of the initial three-dimensional face reconstruction model, this application aims to make the predicted composite image I′ generated by the differentiable renderer close to the training image I inputted into the initial three-dimensional face reconstruction model.

Step 804: Construct a first target loss function according to a difference between the training image and the predicted composite image; and train the initial three-dimensional face reconstruction model on the basis of the first target loss function.

After generating the predicted composite image corresponding to the training image through the differentiable renderer, the server may construct the first target loss function according to the difference between the training image and the predicted composite image. Furthermore, in order to minimize the first target loss function, the model parameters of the initial three-dimensional face reconstruction model are adjusted to train the initial three-dimensional face reconstruction model.

In one possible implementation, the server may construct at least one of an image reconstruction loss function, a key point loss function, and a global perception loss function as the first target loss function.

For example, the server may construct an image reconstruction loss function according to the difference between a face region in the training image and a face region in the predicted composite image. Specifically, the server may determine a face region Iᵢ in the training image I and a face region Iᵢ′ in the predicted composite image I′, and then construct an image reconstruction loss function Lₚ(x) through the following formula (1):

Lₚ(x)=∥Iᵢ−I′ᵢ(x)∥ (1)

For example, the server may perform facial key point detection on the training image and the predicted composite image respectively to obtain a first facial key point set corresponding to the training image and a second facial key point set corresponding to the predicted composite image, and then construct a key point loss function according to a difference between the first facial key point set and the second facial key point set.

Specifically, the server may use a facial key point detector to perform the facial key point detection on the training image and the predicted composite image respectively to obtain the first facial key point set Q (including various key points q in the face region of the training image) corresponding to the training image I and the second facial key point set Q′ (including various key points q′ in the face region of the predicted composite image) corresponding to the predicted composite image I′. Thus, the server may form key point pairs by key points, having correspondence relationships, in the first facial key point set Q and the second facial key point set Q′, and construct the key point loss function Lₗₐₙ(x) by following formula (2) according to position differences between two key points of each key point pair separately belonging to the two facial key point sets:

$${L}_{lan} ( x ) = \frac{1}{N} {\sum }_{n = 1}^{N} {ω}_{n} {‖ {q}_{n} - {q}_{n}^{′} ( x ) ‖}^{2} \qquad ( 2 )$$

where N is a quantity of key points included in each of the first facial key point set Q and the second facial key point set Q′. The first facial key point set Q and the second facial key point set Q′ include the same quantity of key points; qn is an nth key point in the first facial key point set Q, and qn′ is an nth key point in the second facial key point set Q′, and there is a correspondence relationship between qn and qn′; and ωₙ is a weight configured for the nth key point. Different weights may be configured for different key points in the facial key point sets. In this embodiment of this application, the weights of the key points of key parts such as the mouth, eyes, nose, and the like can be increased.

For example, the server may perform deep feature extraction on the training image and the predicted composite image through a facial feature extraction network to obtain a first deep global feature corresponding to the training image and a second deep global feature corresponding to the predicted composite image, and construct a global perception loss function according to a difference between the first deep global feature and the second deep global feature.

Specifically, the server may extract the respective deep global features of the training image I and the predicted composite image I′ through a face recognition network f, that is, a first deep global feature f(I) and a second deep global feature f(I′), then calculate a cosine distance between the first deep global feature f (I) and the second deep global feature f (I′), and construct a global perception loss function Lₚₑᵣ(x) on the basis of the cosine distance. A specific formula for constructing the global perception loss function Lₚₑᵣ(x) is as shown in Formula (3) below:

$${L}_{per} ( x ) = 1 - \frac{〈 f ( I ) , f ( {I}^{′} ( x ) ) 〉}{‖ f ( I ) ‖ \cdot ‖ f ( {I}^{′} ( x ) ‖} \qquad ( 3 )$$

When the server only constructs one of the image reconstruction loss function, the key point loss function, and the global perception loss function, the server may directly use the constructed loss function as the first target loss function, and directly train the initial three-dimensional face reconstruction model on the basis of the first target loss function. When the server constructs various loss functions of the image reconstruction loss function, the key point loss function, and the global perception loss function, the server may use the various constructed loss functions as the first target loss functions. Then, weighted summation is performed on the plurality of first target loss functions, and the initial three-dimensional face reconstruction model is trained using a loss function obtained by the weighted summation.

The server constructs, in the above way, various loss functions on the basis of the difference between the training image and the predicted composite image corresponding thereto, and trains the initial three-dimensional face reconstruction model on the basis of the various loss functions, which is conducive to rapidly improving the performance of the trained initial three-dimensional face reconstruction model, and ensures that the trained three-dimensional face reconstruction model has better performance and the three-dimensional structure can be accurately constructed on the basis of the two-dimensional image.

In one possible implementation, the server may not only construct the loss function for training the initial three-dimensional face reconstruction model on the basis of the difference between the training image and the predicted composite image corresponding thereto, but also construct the loss function for training the initial three-dimensional face reconstruction model on the basis of the predicted three-dimensional face reconstruction parameters generated in the initial three-dimensional face reconstruction model.

That is, the server may construct a regular term loss function as a second target loss function according to the predicted three-dimensional face reconstruction parameters corresponding to the training object. Correspondingly, during the training of the initial three-dimensional face reconstruction model, the server may train the initial three-dimensional face reconstruction model on the basis of the first target loss function and the second target loss function.

Specifically, each three-dimensional face reconstruction parameter itself conforms to a Gaussian normal distribution. Therefore, in consideration of limiting each predicted three-dimensional face reconstruction parameter to a reasonable range, a regular term loss function L_{coef}(x) may be constructed as the second target loss function for training the initial three-dimensional face reconstruction model. The regular term loss function L_{coef}(X) may be specifically constructed by following formula (4):

L_{coef}(x)=ω_{α}∥α∥²+ω_{β}∥β∥²+ω_{δ}∥δ∥² (4)

where α, β, and δ represent the facial shape parameter, facial expression parameter, and facial texture parameter predicted by the predicted three-dimensional face reconstruction model respectively, and ω_{α}, ω_{β}, and ω_{δ} respectively represent the weights separately corresponding to the facial shape parameter, the facial expression parameter, and the facial texture parameter.

When training the initial three-dimensional face reconstruction model on the basis of the first target loss function and the second target loss function, the server may perform the weighted summation on each first target loss function (including at least one of the image reconstruction loss function, the key point loss function, and the global perception loss function) and the second target loss function, and then use the loss function obtained by the weighted summation to train the initial three-dimensional face reconstruction model.

In this way, meanwhile, the initial three-dimensional face reconstruction model is trained on the basis of the first target loss function constructed according to the difference between the training image and the predicted composite image corresponding to the training image, and the second target loss function constructed according to the predicted three-dimensional face reconstruction parameters determined by the initial three-dimensional face reconstruction model, which is conducive to rapidly improving the model performance of the trained initial three-dimensional face reconstruction model, and ensuring that the three-dimensional face reconstruction parameters predicted by the trained initial three-dimensional face reconstruction model have relatively high accuracy.

Step 805: Determine the initial three-dimensional face reconstruction model as a three-dimensional face reconstruction model when the initial three-dimensional face reconstruction model satisfies a first training end condition.

Steps 802 to 804 are cyclically executed on the basis of different training images until it is detected that the trained initial three-dimensional face reconstruction model satisfies the preset first training end condition. The initial three-dimensional face reconstruction model that satisfies the first training end condition may be used as a three-dimensional face reconstruction model put into operation. That is, the three-dimensional face reconstruction model may be used in step 202 in the embodiment shown in FIG. 2. In a possible implementation, the three-dimensional face reconstruction model may be used in step 202 to determine the three-dimensional face reconstruction parameters corresponding to the target object on the basis of the target image including the face of the target object, and construct the three-dimensional facial mesh on the basis of the three-dimensional face reconstruction parameters.

It is understood that the first training end condition mentioned above can be that a reconstruction accuracy of the initial three-dimensional face reconstruction model is greater than a preset accuracy threshold. For example, the server may use the trained initial three-dimensional face reconstruction model to perform three-dimensional reconstruction on test images in a test sample set, generate corresponding predicted composite images on the basis of the reconstructed predicted three-dimensional facial mesh through the differentiable renderer, then determine the reconstruction accuracy of the initial three-dimensional face reconstruction model according to similarities between the various test images and the predicted composite images separately corresponding to the test images, and take, when the reconstruction accuracy is greater than the preset accuracy threshold, the initial three-dimensional face reconstruction model as the three-dimensional face reconstruction model. The above first training end condition may also be that the reconstruction accuracy of the initial three-dimensional face reconstruction model is no longer significantly improved, or that the number of iterative training rounds for the initial three-dimensional face reconstruction model reaches a preset number of rounds, or the like. This application does not impose any limitations on the first training end condition.

The above training method for the three-dimensional face reconstruction model introduces the differentiable renderer in the training process of the three-dimensional face reconstruction model. Through this differentiable renderer, the predicted composite image is generated on the basis of the predicted three-dimensional facial mesh reconstructed by the three-dimensional face reconstruction model, and then the three-dimensional face reconstruction model is trained using the difference between the predicted composite image and the training image inputted into the trained three-dimensional face reconstruction model, thus achieving self-supervised learning of the three-dimensional face reconstruction model. In this way, there is no need to obtain a large number of training samples including training images and three-dimensional face reconstruction parameters corresponding thereto, which saves model training costs and avoids that the accuracy of the trained three-dimensional face reconstruction model is limited by the accuracy of an existing model algorithm.

In one possible implementation, for step 204 of the embodiment shown in FIG. 2, the face creation parameter prediction model can be used to determine the corresponding target face creation parameters according to the target UV map. This embodiment of this application also proposes a self-supervised training method for the face creation parameter prediction model.

A face creation system is given, that is, the face creation system can be used to generate a corresponding three-dimensional facial mesh according to several groups of randomly generated face creation parameters, and the face creation parameters and the corresponding three-dimensional facial mesh are then used to form training samples, thereby obtaining a large number of training samples. In theory, if there are a large number of training samples, regression training of the face creation parameter prediction model used for predicting the face creation parameters according to the UV map can be directly completed using these training samples. However, via researches, the inventor of this application has found that these training methods have significant defects: Specifically, due to the randomly generated face creation parameters in the training samples, there may be a large amount of data in the training samples that do not match a real facial morphology distribution. It may be difficult for the face creation parameter prediction model trained on the basis of the training samples to accurately predict the face creation parameters corresponding to a real facial morphology. That is, if the inputted UV map is not obtained by simulation of the face creation system, but obtained by reconstruction of the three-dimensional face reconstruction model, the performance ability of the face creation parameter prediction model may significantly decrease due to a different distribution of the two types of data. In order to address the aforementioned defect, this embodiment of this application proposes a training method for the face creation parameter prediction model below.

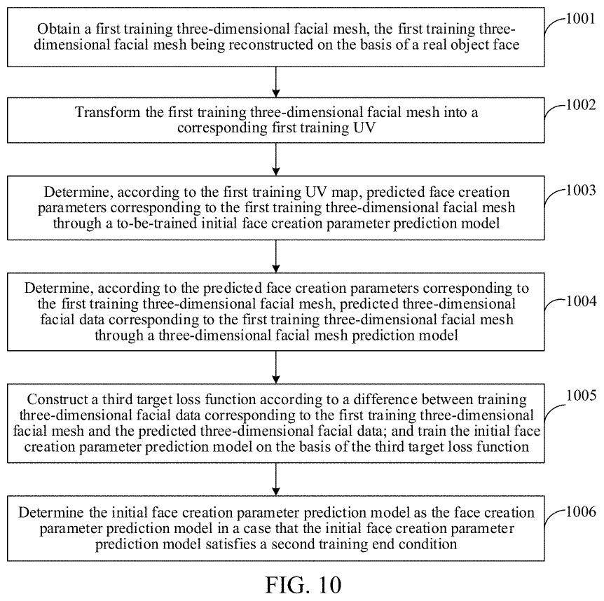

Referring to FIG. 10, FIG. 10 is a flowchart of a training method for a face creation parameter prediction model according to an embodiment of this application. To facilitate description, the following embodiments will be introduced by taking a server serving as an executive body of the model training method as an example. It is understood that the model training method may also be performed by other computer devices (such as a terminal device) in practical applications. As shown in FIG. 10, the model training method includes the following steps:

Step 1001: Obtain a first training three-dimensional facial mesh, the first training three-dimensional facial mesh being reconstructed on the basis of a real object face.

Before training the face creation parameter prediction model, the server needs to first obtain training samples used for training the face creation parameter prediction model, that is, obtain a large number of first training three-dimensional facial meshes. In order to ensure that the trained face creation parameter prediction model can accurately predict the face creation parameters corresponding to the real object face, the obtained first training three-dimensional facial mesh is reconstructed on the basis of the real object face.

For example, the server may reconstruct a large number of three-dimensional facial meshes on the basis of a real human facial data set CelebA as the first training three-dimensional facial mesh mentioned above.

Step 1002: Transform the first training three-dimensional facial mesh into a corresponding first training UV map.

Due to the fact that the to-be-trained face creation parameter prediction model in this embodiment of this application predicts the face creation parameters on the basis of the UV map, after obtaining the first training three-dimensional facial mesh, the server also needs to transform the obtained first training three-dimensional facial mesh into a corresponding UV map, namely, the first training UV map. The first training UV map is used to carry position data of various vertices on the first training three-dimensional facial mesh. A specific implementation of transforming the three-dimensional facial mesh into the corresponding UV map may refer to the relevant introduction of step 203 in the embodiment shown in FIG. 2, and will not be repeated here.

Step 1003: Determine, according to the first training UV map, predicted face creation parameters corresponding to the first training three-dimensional facial mesh through a to-be-trained initial face creation parameter prediction model.

After obtaining the first training UV map corresponding to the first training three-dimensional facial mesh by transformation, the server may train the initial face creation parameter prediction model on the basis of the first training UV map. The initial face creation parameter prediction model is a training basis of the face creation parameter prediction model in the embodiment shown in FIG. 2. A structure of the initial face creation parameter prediction model is the same as that of the face creation parameter prediction model in the embodiment shown in FIG. 2, but model parameters of the initial face creation parameter prediction model are obtained by initialization.

During the training of the initial face creation parameter prediction model, the server may input the first training UV map into the initial face creation parameter prediction model. The initial face creation parameter prediction model may correspondingly output, by analyzing the first training UV map, the predicted face creation parameters corresponding to the first training three-dimensional facial mesh.

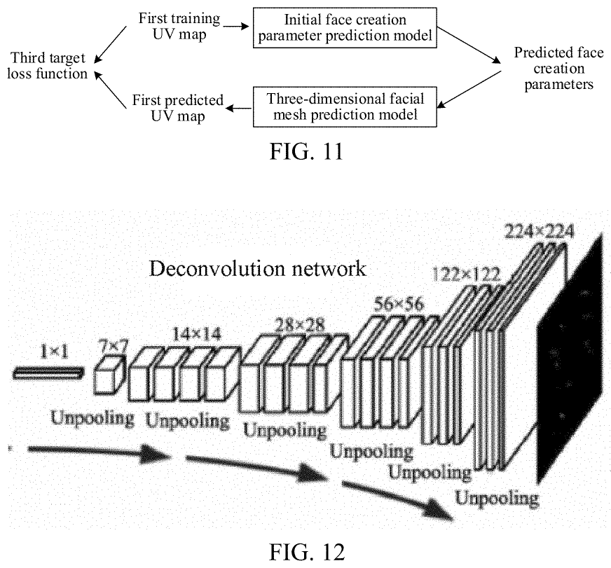

For example, FIG. 11 is a schematic diagram of a training architecture of a face creation parameter prediction model according to an embodiment of this application. As shown in FIG. 11, the server may input a first training UV map into an initial face creation parameter prediction model mesh2param. The mesh2param may correspondingly output corresponding predicted face creation parameters param by analyzing the first training UV map. The initial face creation parameter prediction model used here can be ResNet-18, for example.

Step 1004: Determine, according to the predicted face creation parameters corresponding to the first training three-dimensional facial mesh, predicted three-dimensional facial data corresponding to the first training three-dimensional facial mesh through a three-dimensional facial mesh prediction model.

After the server predicts the predicted face creation parameters corresponding to the first training three-dimensional facial mesh through the initial face creation parameter prediction model, the server may further use a pre-trained three-dimensional facial mesh prediction model to generate, according to the predicted face creation parameters corresponding to the first training three-dimensional facial mesh, the predicted three-dimensional facial data corresponding to the first training three-dimensional facial mesh. The three-dimensional facial mesh prediction model is a model for predicting three-dimensional facial data according to face creation parameters.

In one possible implementation, the predicted three-dimensional facial data determined by the server through the three-dimensional facial mesh prediction model may be a UV map. The server may determine, according to the predicted face creation parameters corresponding to the first training three-dimensional facial mesh, the first predicted UV map corresponding to the first training three-dimensional facial mesh through the three-dimensional facial mesh prediction model. That is, the three-dimensional facial mesh prediction model is a model for predicting, according to face creation parameters, a UV map used for carrying three-dimensional structure information.

As shown in FIG. 11, after generating the predicted face creation parameters corresponding to the first training three-dimensional facial mesh through the initial face creation parameter prediction model, the server may further use the three-dimensional facial mesh prediction model param2mesh to generate, according to the predicted face creation parameters, the first predicted UV map corresponding to the first training three-dimensional facial mesh. In this way, the three-dimensional facial mesh prediction model is used for predicting the UV map, which is conducive to subsequent construction of a loss function based on a difference between a training UV map and a predicted UV map, and is more helpful to assist in improving the model performance of the trained initial face creation parameter prediction model.

The three-dimensional facial mesh prediction model used in this implementation may be trained in a following manner: obtaining a mesh prediction training sample, the mesh prediction training sample including training face creation parameters and a second training three-dimensional facial mesh corresponding to the training face creation parameters, and the second training three-dimensional facial mesh here being generated by a face creation system on the basis of the training face creation parameters corresponding to the training three-dimensional facial mesh; transforming the second training three-dimensional facial mesh in the mesh prediction training sample into a corresponding second training UV map; determining a second predicted UV map through a to-be-trained initial three-dimensional facial mesh prediction model according to the training face creation parameters in the mesh prediction training sample; constructing a fourth target loss function according to a difference between the second training UV map and the second predicted UV map; training the initial three-dimensional facial mesh prediction model on the basis of the fourth target loss function; and taking the initial three-dimensional facial mesh prediction model as the above three-dimensional facial mesh prediction model when it is determined that the initial three-dimensional facial mesh prediction model satisfies a third training end condition.

Specifically, the server may randomly generate several groups of training face creation parameters in advance. For each group of training face creation parameters, the server may use the face creation system to generate a corresponding three-dimensional facial mesh on the basis of this group of training face creation parameters as a second training three-dimensional facial mesh corresponding to this group of training face creation parameters, and then use this group of training face creation parameters and the second training three-dimensional facial mesh corresponding thereto to form a mesh prediction training sample. In this way, the server may generate a large number of mesh prediction training samples in the above manner on the basis of the several groups of randomly generated training face creation parameters.

Due to the use of the three-dimensional facial mesh prediction model in this implementation, the UV map used for carrying the three-dimensional structure information of the three-dimensional facial mesh is predicted on the basis of the face creation parameters. Therefore, the server also needs to transform, for each mesh prediction training sample, the second training three-dimensional facial mesh into a corresponding second training UV map. Specifically, the implementation of transforming the three-dimensional facial mesh into the corresponding UV map may refer to the relevant introduction content of step 203 in the embodiment shown in FIG. 2, and will not be repeated here.

The server may input the training face creation parameters in the mesh prediction training sample into the to-be-trained initial three-dimensional facial mesh prediction model. The initial three-dimensional facial mesh prediction model correspondingly outputs the second predicted UV map by analyzing the inputted training face creation parameters. For example, the server may regard p training face creation parameters in the mesh prediction training sample as single pixel points, with a feature channel quantity of p, that is, a size of an input feature is [1, 1, p], as shown in FIG. 12. This embodiment of this application can use a deconvolution form to gradually deconvolute and upsample features with the size of [1, 1, p], and ultimately expand the features into a second predicted UV map with a size of [256, 256, 3].

Thus, the server may construct the fourth target loss function according to the difference between the second training UV map and the second predicted UV map in the mesh prediction training sample, make the fourth target loss function converge as a training target, and adjust model parameters of the initial three-dimensional facial mesh prediction model to train the initial three-dimensional facial mesh prediction model. When it is confirmed that the initial three-dimensional facial mesh prediction model satisfies the third training end condition, the server may determine the completion of the training of the initial three-dimensional facial mesh prediction model, and take the initial three-dimensional facial mesh prediction model as the three-dimensional facial mesh prediction model.

It is understood that the third training end condition here may be that a prediction accuracy of the trained initial three-dimensional facial mesh prediction model reaches a preset accuracy threshold, or that the model performance of the trained initial three-dimensional facial mesh prediction model is no longer significantly improved, or that the number of iterative training rounds for the initial three-dimensional facial mesh prediction model reaches a preset number of rounds. This application does not impose any restrictions on the third training end condition.

In another possible implementation, the predicted three-dimensional facial data determined by the server through the three-dimensional facial mesh prediction model may be a three-dimensional facial mesh. That is, the server may determine, according to the predicted face creation parameters corresponding to the first training three-dimensional facial mesh, a first predicted three-dimensional facial mesh corresponding to the first training three-dimensional facial mesh through the three-dimensional facial mesh prediction model. That is, the three-dimensional facial mesh prediction model is a model for predicting a three-dimensional facial mesh according to face creation parameters.

For example, after generating the predicted face creation parameters corresponding to the first training three-dimensional facial mesh through the initial face creation parameter prediction model, the server may further use the three-dimensional facial mesh prediction model to generate, on the basis of the predicted face creation parameters, the first predicted three-dimensional facial mesh corresponding to the first training three-dimensional facial mesh. In this way, the three-dimensional facial mesh prediction model is used for predicting the three-dimensional facial mesh, which is conducive to subsequent construction of a loss function based on a difference between a training three-dimensional facial mesh itself and the predicted three-dimensional facial mesh, and is also conductive to improving the model performance of the trained initial face creation parameter prediction model.

The three-dimensional facial mesh prediction model used in this implementation may be trained in a following manner: obtaining a mesh prediction training sample, the mesh prediction training sample including training face creation parameters and a second training three-dimensional facial mesh corresponding to the training face creation parameters, and the second training three-dimensional facial mesh here being generated by a face creation system on the basis of the training face creation parameters corresponding to the training three-dimensional facial mesh; determining a second predicted three-dimensional facial mesh through the to-be-trained initial three-dimensional facial mesh prediction model according to the training face creation parameters in the mesh prediction training sample; constructing a fifth target loss function according to a difference between the second training three-dimensional facial mesh and the second predicted three-dimensional facial mesh; training the initial three-dimensional facial mesh prediction model on the basis of the fifth loss function; and taking the initial three-dimensional facial mesh prediction model as the three-dimensional facial mesh prediction model when it is determined that the initial three-dimensional facial mesh prediction model satisfies a fourth training end condition.

Specifically, the server may randomly generate several groups of training face creation parameters in advance. For each group of training face creation parameters, the server may use the face creation system to generate a corresponding three-dimensional facial mesh on the basis of this group of training face creation parameters as a second training three-dimensional facial mesh corresponding to this group of training face creation parameters, and then use this group of training face creation parameters and the second training three-dimensional facial mesh corresponding thereto to form a mesh prediction training sample. In this way, the server may generate a large number of mesh prediction training samples in the above manner on the basis of the several groups of randomly generated training face creation parameters.

The server may input the training face creation parameters in the mesh prediction training sample into the to-be-trained initial three-dimensional facial mesh prediction model. The initial three-dimensional facial mesh prediction model correspondingly outputs the second predicted three-dimensional facial mesh by analyzing the inputted training face creation parameters.

Thus, the server may construct the fifth target loss function according to the difference between the second training three-dimensional facial mesh and the second predicted three-dimensional facial mesh in the mesh prediction training sample. Specifically, the server may construct the fifth target loss function according to a position difference between vertices, having a correspondence relationship, in the second training three-dimensional facial mesh and the second predicted three-dimensional facial mesh, and make the fifth target loss function converge as a training target, and adjust model parameters of the initial three-dimensional facial mesh prediction model to train the initial three-dimensional facial mesh prediction model. When it is confirmed that the initial three-dimensional facial mesh prediction model satisfies the fourth training end condition, the server may determine the completion of the training of the initial three-dimensional facial mesh prediction model, and take the initial three-dimensional facial mesh prediction model as the three-dimensional facial mesh prediction model.

It is understood that the fourth training end condition here may be that a prediction accuracy of the trained initial three-dimensional facial mesh prediction model reaches a preset accuracy threshold, or that the model performance of the trained initial three-dimensional facial mesh prediction model is no longer significantly improved, or that the number of iterative training rounds for the initial three-dimensional facial mesh prediction model reaches a preset number of rounds. This application does not impose any restrictions on the third training end condition.

Step 1005: Construct a third target loss function according to a difference between training three-dimensional facial data corresponding to the first training three-dimensional facial mesh and the predicted three-dimensional facial data; and train the initial face creation parameter prediction model on the basis of the third target loss function.

After obtaining the predicted three-dimensional facial data corresponding to the first training three-dimensional facial mesh in step 1004, the server may construct the third target loss function according to the difference between the training three-dimensional facial data corresponding to the first training three-dimensional facial mesh and the predicted three-dimensional facial data, and make the third target loss function converge as a training target, and adjust model parameters of the initial face creation parameter prediction model to train the initial face creation parameter prediction model.

In one possible implementation, if the three-dimensional facial mesh prediction model used in step 1004 is a model for predicting a UV map, the three-dimensional facial mesh prediction model outputs, on the basis of the predicted face creation parameters corresponding to the inputted first training three-dimensional facial mesh, the first predicted UV map corresponding to the first training three-dimensional facial mesh. At this time, the server may construct the above third target loss function according to the difference between the first training UV map corresponding to the first training three-dimensional facial mesh and the first predicted UV map.

As shown in FIG. 11, the server may construct, according to the difference between the first training UV map inputted to the initial face creation parameter prediction model and the first predicted UV map outputted by the three-dimensional facial mesh prediction model, the third target loss function used for training the initial face creation parameter prediction model. Specifically, the server may construct the third target loss function according to the difference between an image feature of the first training UV map and an image feature of the first predicted UV map.

In another possible implementation, if the three-dimensional facial mesh prediction model used in step 1004 is a model for predicting a three-dimensional facial mesh, the three-dimensional facial mesh prediction model outputs, on the basis of the predicted face creation parameters corresponding to the inputted first training three-dimensional facial mesh, the first predicted three-dimensional facial mesh corresponding to the first training three-dimensional facial mesh. At this time, the server may construct the above third target loss function according to the difference between the first training three-dimensional facial mesh and the first predicted three-dimensional facial mesh.

Specifically, the server may construct the third target loss function according to a position difference between vertices, having a correspondence relationship, in the first training three-dimensional facial mesh and the first predicted three-dimensional facial mesh.

Step 1006: Determine the initial face creation parameter prediction model as the face creation parameter prediction model when the initial face creation parameter prediction model satisfies a second training end condition.

Steps 1002 to 1004 are cyclically executed on the basis of different first training three-dimensional facial meshes until it is detected that the trained initial face creation parameter prediction model satisfies a preset second training end condition. Then, the initial face creation parameter prediction model that satisfies the second training end condition may be used as a face creation parameter prediction model put into operation. In one possible implementation, the face creation parameter prediction model can be used in step 204 of the embodiment shown in FIG. 2. The face creation parameter prediction model is used for determining the corresponding target face creation parameters according to the target UV map.

It is understood that the second training end condition mentioned above can be that a prediction accuracy of the initial face creation parameter model reaches a preset accuracy threshold. For example, the server may use the trained initial face creation parameter prediction model to determine the corresponding predicted face creation parameters on the basis of test UV maps in a test sample set, and generate predicted UV maps on the basis of the predicted face creation parameters through the three-dimensional facial mesh prediction model. Furthermore, the server determines the prediction accuracy of the initial face creation parameters on the basis of similarities between the various test UV maps and the predicted UV maps corresponding thereto; and take the initial face creation parameter prediction model as the face creation parameter prediction model when the prediction accuracy is greater than the preset accuracy threshold. The above first training end condition may also be that the prediction accuracy of the initial face creation parameter prediction model is no longer significantly improved, or that the number of iterative training rounds of the initial face creation parameter prediction model reaches a preset number rounds, or the like. This application does not impose any limitations on the second training end condition.

In the above training method for the face creation parameter prediction model, in the process of training the face creation parameter prediction model, the pre-trained three-dimensional facial mesh prediction model is used to restore the corresponding UV map on the basis of the predicted face creation parameters determined by the trained face creation parameter prediction model. Furthermore, the face creation parameter prediction model is trained using the difference between the restored UV map and the UV map inputted into the face creation parameter prediction model, achieving the self-supervised learning of the face creation parameter prediction model. Due to the fact that the training samples used for training the face creation parameter prediction model are all constructed on the basis of the real object face, it can be ensured that the trained face creation parameter prediction model can accurately predict the face creation parameters corresponding to the real facial morphology, ensuring the prediction accuracy of the face creation parameter prediction model.

In order to facilitate a further understanding of the image processing method provided in this embodiment of this application, use of the image processing method to achieve a face creation function in a game application is taken as an example to provide an overall exemplary introduction to the image processing method.

When a user uses a game application, the user can choose to use the face creation function in the game application to generate personalized virtual character facial image. Specifically, an interface of the face creation function of the game application may include an image upload control. After clicking the image upload control, the user can locally select an image including a clear and complete face from a terminal device as a target image. For example, the user can select a selfie as the target image. After the game application detects that the user has completed the selection of the target image, the terminal device may be caused to transmit the selected target image to a server.

After receiving the target image, the server may first use a 3DMM to reconstruct a three-dimensional facial mesh corresponding to the face in the target image. Specifically, the server may input the target image into the 3DMM, and the 3DMM may correspondingly determine a face region in the target image and determine, on the basis of the face region, three-dimensional face reconstruction parameters corresponding to the face, for example, a facial shape parameter, a facial expression parameter, a facial posture parameter, and a facial texture parameter. Furthermore, the 3DMM may construct a three-dimensional facial mesh corresponding to the face in the target image according to the determined three-dimensional face reconstruction parameters.

Then, the server may transform the three-dimensional facial mesh corresponding to the face into a corresponding target UV map, that is, the server may map, on the basis of a correspondence relationship between vertices on a preset three-dimensional facial mesh and pixel points in a basic UV map, position data of various vertices on the three-dimensional facial mesh corresponding to the face into RGB channel values of the corresponding pixel points in the basic UV map, and correspondingly determine RGB channel values of other pixel points in the basic UV map on the basis of the RGB channel values of the pixel points, corresponding to the mesh vertices, in the basic UV map. Thus, the target UV map is obtained.

Furthermore, the server may input the target UV map into the ResNet-18 model, and the ResNet-18 model is a pre-trained face creation parameter prediction model. The ResNet-18 model may determine, by analyzing the inputted target UV map, to determine target face creation parameters corresponding to the face in the target image. After determining the target face creation parameters, the server may feed back the target face creation parameters to the terminal device.

Finally, the game application in the terminal device may use its own running face creation system to generate, according to the target face creation parameters, a target virtual facial image that matches the face in the target image. If the user still needs to adjust the target virtual facial image, the user can also correspondingly adjust the target virtual facial image by using an adjustment slider in the interface of the face creation function.

It is understood that the image processing method provided in this embodiment of this application can not only be used to implement the face creation function in the game application, but also be used to implement the face creation function in other types of applications (such as a short video application and an image processing application). There is no specific limitation on application scenarios of the image processing method provided in this embodiment of this application.

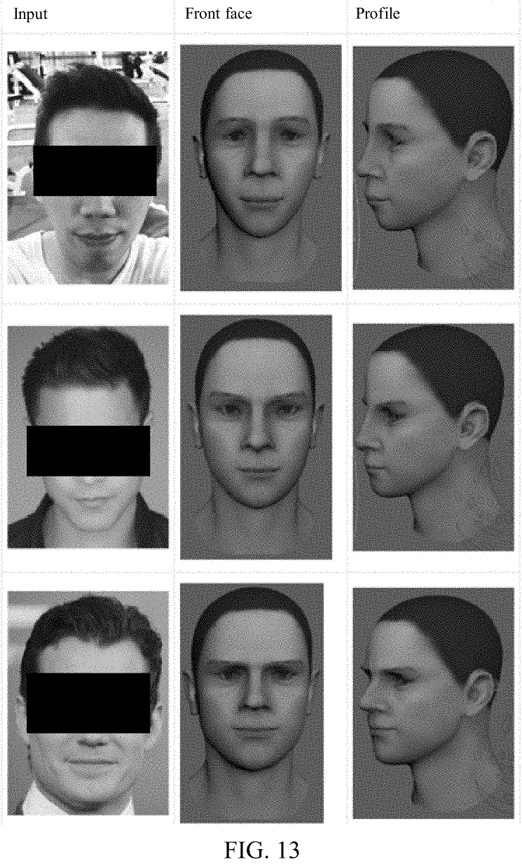

FIG. 13 shows experimental results using an image processing method according to an embodiment of this application. As shown in FIG. 13, the image processing method provided in this embodiment of this application is used to process three inputted images, to obtain virtual facial images corresponding to the faces in the three images. Whether viewed from the front or the profile, the generated virtual facial images have a high degree of matching with the faces in the inputted images. From the profile, the three-dimensional structures of the generated virtual facial images accurately match the three-dimensional structures of the real faces.

In response to the image processing method described above, this application further provides a corresponding image processing apparatus to apply and implement the above image processing method in practice.

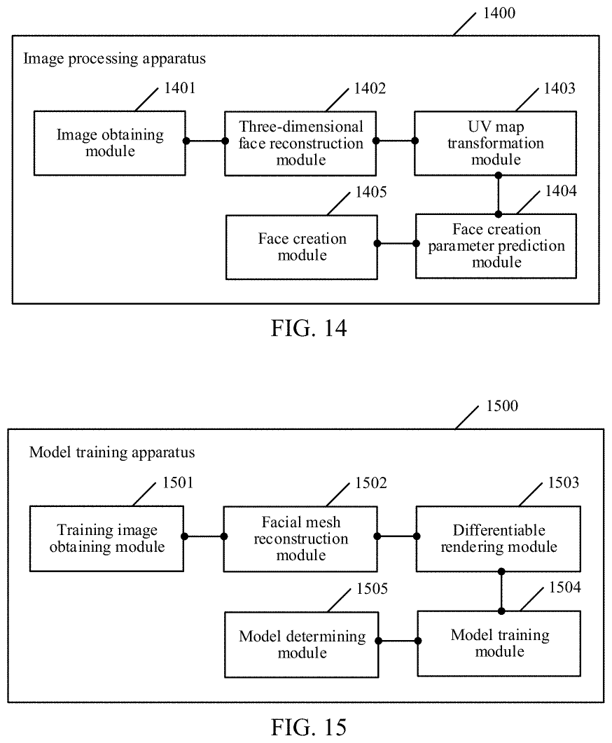

Referring to FIG. 14, FIG. 14 is a schematic structural diagram of an image processing apparatus 1400 corresponding to the image processing method shown in FIG. 2 above. As shown in FIG. 14, the image processing apparatus 1400 includes:
an image obtaining module 1401, configured to obtain a target image, the target image including the face of a target object;
a three-dimensional face reconstruction module 1402, configured to construct, according to the target image, a three-dimensional facial mesh corresponding to the target object;
a UV map transformation module 1403, configured to transform the three-dimensional facial mesh into a target UV map, the target UV map being used for carrying position data of various vertices on the three-dimensional facial mesh;
a face creation parameter prediction module 1404, configured to determine target face creation parameters according to the target UV map; and
a face creation module 1405, configured to generate, according to target face creation parameters, a target virtual facial image corresponding to the target object.

In some embodiments, based on the image processing apparatus shown in FIG. 14, the UV map transformation module 1403 is specifically configured to:
determine color channel values of the pixel points in the basic UV map on the basis of a correspondence relationship between the vertices on the three-dimensional facial mesh and pixel points in a basic UV map and the position data of the various vertices on the three-dimensional facial mesh; and
determine the target UV map on the basis of the color channel values of the pixel points in the basic UV map.

In some embodiments, based on the image processing apparatus shown in FIG. 14, the UV map transformation module 1403 is specifically configured to:

for each patch on the three-dimensional facial mesh, determine, on the basis of the correspondence relationship, pixel points separately corresponding to the vertices in the patch from the basic UV map, and determine a color channel value of the corresponding pixel point according to the position data of each vertex;

determine a coverage region of the patch in the basic UV map according to the pixel points separately corresponding to the various vertices in the patch, and rasterize the coverage region; and

interpolate, on the basis of a quantity of pixel points included in the rasterized coverage region, the color channel values of the pixel points separately corresponding to the vertices in the patch, and take the interpolated color channel values as color channel values of the pixel points in the rasterized coverage region.

In some embodiments, based on the image processing apparatus shown in FIG. 14, the UV map transformation module 1403 is specifically configured to:
determine a reference UV map on the basis of the color channel values of the respective pixel points in a target mapping region in the basic UV map, the target mapping region including coverage regions, in the basic UV map, of various patches on the three-dimensional facial mesh corresponding to the target object; and
mend the reference UV map when the target mapping region not completely covering the basic UV map, to obtain the target UV map.

In some embodiments, based on the image processing apparatus shown in FIG. 14, the three-dimensional face reconstruction module 1402 is specifically configured to:
determine, according to the target image, three-dimensional face reconstruction parameters corresponding to the target object by using a three-dimensional face reconstruction model; and construct the three-dimensional facial mesh on the basis of the three-dimensional face reconstruction parameters.

In the above image processing apparatus, the three-dimensional facial mesh corresponding to the target object is constructed according to the target image, so that three-dimensional structure information of the face of the target object in the target image is determined. Considering a high difficulty in directly predicting the face creation parameters on the basis of the three-dimensional facial mesh, this embodiment of this application cleverly proposes an implementation of using a UV map to carry the three-dimensional structure information, that is, using the target UV map to carry the position data of the various vertices in the three-dimensional facial mesh corresponding to the target object, thereby determining the target face creation parameters corresponding to the face of the target object according to the target UV map. In this way, prediction of the face creation parameters based on a three-dimensional grid structure is transformed into prediction of the face creation parameters based on a two-dimensional UV map, which reduces the difficulty of predicting the face creation parameters and improving the accuracy of predicting the face creation parameters, so that the predicted target face creation parameters can accurately represent the three-dimensional structure of the face of the target object. Correspondingly, the three-dimensional structure of the target virtual facial image generated on the basis of the target face creation parameters can accurately match the three-dimensional structure of the face of the target object, so that the problem of deep distortion is avoided, and the accuracy and efficiency of the generated virtual facial image are improved.

Based on the embodiments corresponding to the foregoing FIG. 1 to FIG. 12 and mainly based on the embodiments of model training corresponding to FIG. 8 to FIG. 12, the embodiments of this application further provide a model training apparatus. As shown in FIG. 15, the model training apparatus 1500 includes:
a training image obtaining module 1501, configured to obtain a training image, the training image including the face of a training object;
a facial mesh reconstruction module 1502, configured to determine, according to the training image, predicted three-dimensional face reconstruction parameters corresponding to the training object by using a to-be-trained initial three-dimensional face reconstruction model, and construct, on the basis of the predicted three-dimensional face reconstruction parameters corresponding to the training object, a predicted three-dimensional facial mesh corresponding to the training object;
a differentiable rendering module 1503, configured to generate a predicted composite image through a differentiable renderer according to the predicted three-dimensional facial mesh;
a model training module 1504, configured to construct a first target loss function according to a difference between the training image and the predicted composite image, and train the initial three-dimensional face reconstruction model on the basis of the first target loss function; and
a model determining module 1505, configured to determine the initial three-dimensional face reconstruction model as a three-dimensional face reconstruction model when the initial three-dimensional face reconstruction model satisfies a first training end condition, the three-dimensional face reconstruction model being used for determining three-dimensional face reconstruction parameters corresponding to the target object according to the target image including the face of the target object, and constructing the three-dimensional facial mesh on the basis of the three-dimensional face reconstruction parameters.

In some embodiments, the model training module is specifically configured to construct the first target loss function by at least one of following manners:
constructing an image reconstruction loss function as the first target loss function according to a difference between a face region in the training image and a face region in the predicted composite image;
performing facial key point detection on the training image and the predicted composite image respectively to obtain a first facial key point set corresponding to the training image and a second facial key point set corresponding to the predicted composite image, and constructing a key point loss function as the first target loss function according to a difference between the first facial key point set and the second facial key point set; and
performing deep feature extraction on the training image and the predicted composite image through a facial feature extraction network to obtain a first deep global feature corresponding to the training image and a second deep global feature corresponding to the predicted composite image, and constructing a global perception loss function as the first target loss function according to a difference between the first deep global feature and the second deep global feature.

In some embodiments, the model training module is further configured to:
construct a regular term loss function as a second target loss function according to the predicted three-dimensional face reconstruction parameters; and
train the initial three-dimensional face reconstruction model on the basis of the first target loss function and the second target loss function.

In some embodiments, based on the image processing apparatus shown in FIG. 14, the face creation parameter prediction module 1404 is specifically configured to:
determine the target face creation parameters according to the target UV map through a face creation parameter prediction model.

The model training apparatus in FIG. 15 further includes: a training mesh obtaining module, configured to obtain a first training three-dimensional facial mesh, the first training three-dimensional facial mesh being reconstructed on the basis of a real object face;
a UV map transformation module, configured to transform the first training three-dimensional facial mesh into a corresponding first training UV map;
a parameter prediction module, configured to determine, according to the first training UV map, predicted face creation parameters corresponding to the first training three-dimensional facial mesh through a to-be-trained initial face creation parameter prediction model; and
a three-dimensional reconstruction module, configured to: determine, according to the predicted face creation parameters corresponding to the first training three-dimensional facial mesh, predicted three-dimensional facial data corresponding to the first training three-dimensional facial mesh through a three-dimensional facial mesh prediction model.

The model training module is further configured to: construct a third target loss function according to a difference between training three-dimensional facial data corresponding to the first training three-dimensional facial mesh and the predicted three-dimensional facial data; and train the initial face creation parameter prediction model on the basis of the third target loss function.

The model determining module is further configured to determine the initial face creation parameter prediction model as the face creation parameter prediction model when the initial face creation parameter prediction model satisfies a second training end condition, the face creation parameter prediction model being used for determining corresponding target face creation parameters according to a target UV map, the target UV map being transformed from the three-dimensional facial mesh, the target UV map being used for carrying position data of various vertices on the three-dimensional facial mesh, and the target face creation parameters being used for generating a target virtual facial image corresponding to the target object.

In some embodiments, the three-dimensional reconstruction module is specifically configured to:
determine, according to the predicted face creation parameters corresponding to the first training three-dimensional facial mesh, a first predicted UV map corresponding to the first training three-dimensional facial mesh through the three-dimensional facial mesh prediction model.

Correspondingly, the model training module is specifically configured to:
construct the third target loss function according to a difference between the first training UV map and the first predicted UV map.

In some embodiments, the model training apparatus further includes: a first three-dimensional prediction model training module. The first three-dimensional prediction model training module is configured to:
obtain a mesh prediction training sample, the mesh prediction training sample including training face creation parameters and a second training three-dimensional facial mesh corresponding to the training face creation parameters, and the second training three-dimensional facial mesh being generated by a face creation system on the basis of the training face creation parameters corresponding to the training three-dimensional facial mesh;
transform the second training three-dimensional facial mesh in the mesh prediction training sample into a corresponding second training UV map;
determine a second predicted UV map through a to-be-trained initial three-dimensional facial mesh prediction model according to the training face creation parameters in the mesh prediction training sample;
construct a fourth target loss function according to a difference between the second training UV map and the second predicted UV map; train the initial three-dimensional facial mesh prediction model on the basis of the fourth target loss function; and
determine the initial three-dimensional facial mesh prediction model as the three-dimensional facial mesh prediction model when the initial three-dimensional facial mesh prediction model satisfies a third training end condition.

In some embodiments, the three-dimensional reconstruction module is specifically configured to:
determine, according to the predicted face creation parameters corresponding to the first training three-dimensional facial mesh, a first predicted three-dimensional facial mesh corresponding to the first training three-dimensional facial mesh through the three-dimensional facial mesh prediction model.

Correspondingly, the model training module is specifically configured to:
construct the third target loss function according to a difference between the first training three-dimensional facial mesh and the first predicted three-dimensional facial mesh.

In some embodiments, the parameter prediction model training module further includes: a second three-dimensional prediction model training sub-module. The second three-dimensional prediction model training sub-module is configured to:
obtain a mesh prediction training sample, the mesh prediction training sample including training face creation parameters and a second training three-dimensional facial mesh corresponding to the training face creation parameters, and the second training three-dimensional facial mesh being generated by a face creation system on the basis of the training face creation parameters corresponding to the training three-dimensional facial mesh;
determine a second predicted three-dimensional facial mesh through the to-be-trained initial three-dimensional facial mesh prediction model according to the training face creation parameters in the mesh prediction training sample;
construct a fifth target loss function according to a difference between the second training three-dimensional facial mesh and the second predicted three-dimensional facial mesh; train the initial three-dimensional facial mesh prediction model on the basis of the fifth target loss function; and
determine the initial three-dimensional facial mesh prediction model as the three-dimensional facial mesh prediction model when the initial three-dimensional facial mesh prediction model satisfies a fourth training end condition.

The above model training apparatus introduces the differentiable renderer in the training process of the three-dimensional face reconstruction model. Through this differentiable renderer, the predicted composite image is generated on the basis of the predicted three-dimensional facial mesh reconstructed by the three-dimensional face reconstruction model, and then the three-dimensional face reconstruction model is trained using the difference between the predicted composite image and the training image inputted into the trained three-dimensional face reconstruction model, thus achieving self-supervised learning of the three-dimensional face reconstruction model. In this way, there is no need to obtain a large number of training samples including training images and three-dimensional face reconstruction parameters corresponding thereto, which saves model training costs and avoids that the accuracy of the trained three-dimensional face reconstruction model is limited by the accuracy of an existing model algorithm.

The embodiments of this application further provide a computer device for achieving a face creation function. The computer device may specifically be a terminal device or a server. The terminal device and the server provided in this embodiment of this application will be described below in view of hardware materialization.

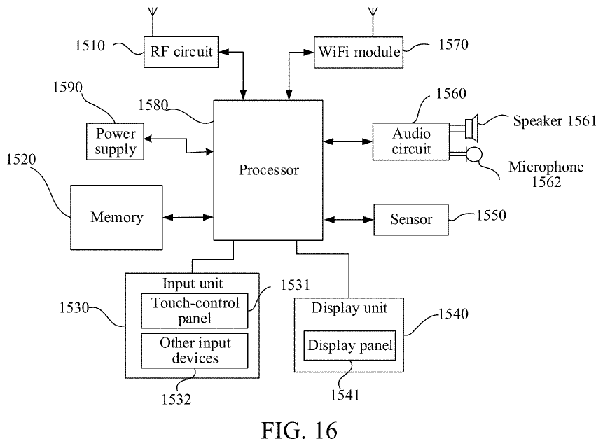

Referring to FIG. 16, FIG. 16 is a schematic structural diagram of a terminal device according to an embodiment of this application. As shown in FIG. 16, for ease of description, only parts related to this embodiment of this application are shown. For specific technical details that are not disclosed, refer to the method part in the embodiments of this application. The terminal may be any terminal device including a mobile phone, a tablet computer, a personal digital assistant, a point of sales (POS), a vehicle-mounted computer, and the like. The terminal being a computer is used as an example:

FIG. 16 shows a block diagram of some structures of the computer related to the terminal according to an embodiment of this application. Referring to FIG. 16, the computer includes: a radio frequency (RF) circuit 1510, a memory 1520, an input unit 1530 (including a touch-control panel 1531 and other input devices 1532), a display unit 1540 (including a display panel 1541), a sensor 1550, an audio circuit 1560 (which may be connected to a speaker 1561 and a microphone 1562), a wireless fidelity (WiFi) module 1570, a processor 1580, and a power supply 1590. A person of skill in the art can understand that the structures of the computer device shown in FIG. 16 do not constitute a limitation on the computer, and may include components that are more or fewer than those shown in the figure, or a combination of some components, or different component arrangements.

The memory 1520 may be configured to store a software program and modules. The processor 1580 runs the software program and modules stored in the memory 1520, to implement various functional applications and data processing of the computer.

The processor 1580 is a control center of the computer, and is connected to various parts of the entire computer by using various interfaces and lines. By running or executing the software program and/or modules stored in the memory 1520, and invoking data stored in the memory 1520, the processor executes the various functions of the computer and processes data.

In this embodiment of this application, the processor 1580 included in the terminal further has the following functions:
obtaining a target image; the target image including the face of a target object;
constructing, according to the target image, a three-dimensional facial mesh corresponding to the target object;
transforming the three-dimensional facial mesh into a target UV map, the target UV map being used for carrying position data of various vertices on the three-dimensional facial mesh;
determining target face creation parameters according to the target UV map; and
generating, on the basis of the target face creation parameters, a target virtual facial image corresponding to the target object.

In some embodiments, the processor 1580 is further configured to execute the steps of any implementation of the image processing method provided in the embodiments of this application.

In this embodiment of this application, the processor 1580 included in the terminal further has the following functions:
obtaining a training image, the training image including the face of a training object;
determining, according to the training image, predicted three-dimensional face reconstruction parameters corresponding to the training object by using a to-be-trained initial three-dimensional face reconstruction model; and constructing, according to the predicted corresponding to the training object;
generating a predicted composite image through a differentiable renderer according to the predicted three-dimensional facial mesh;
constructing a first target loss function according to a difference between the training image and the predicted composite image; training the initial three-dimensional face reconstruction model on the basis of the first target loss function; and
determining the initial three-dimensional face reconstruction model as a three-dimensional face reconstruction model when the initial three-dimensional face reconstruction model satisfies a first training end condition, the three-dimensional face reconstruction model being used for determining three-dimensional face reconstruction parameters corresponding to the target object according to the target image including the face of the target object, and constructing the three-dimensional facial mesh on the basis of the three-dimensional face reconstruction parameters.

In some embodiments, the processor 1580 is further configured to execute the steps of any implementation of the model training method provided in the embodiments of this application.

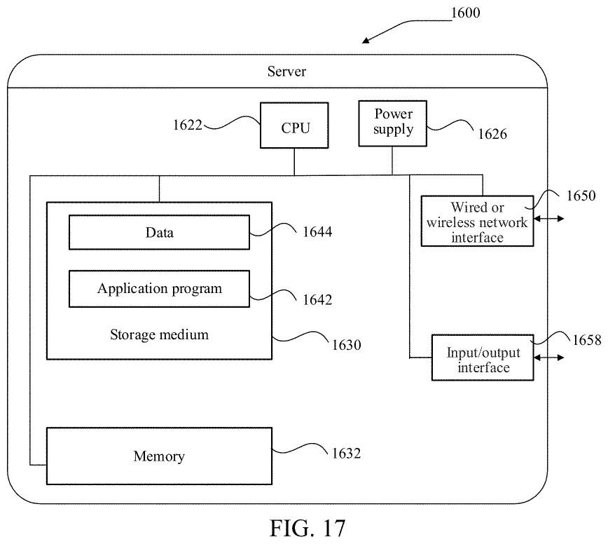

Referring to FIG. 17, FIG. 17 is a schematic structural diagram of a server 1600 according to an embodiment of this application. The server 1600 may vary greatly due to different configurations or performance, and may include one or more central processing units (CPUs) 1622 (for example, one or more processors), a memory 1632, and one or more storage media 1630 (for example, one or more mass storage devices) that store application programs 1642 or data 1644. The memories 1632 and the storage media 1630 may be used for transitory storage or permanent storage. A program stored in the storage medium 1630 may include one or more modules (which are not shown in the figure), and each module may include a series of instruction operations on the server. Further, the CPU 1622 may be configured to communicate with the storage medium 1630, and perform, on the server 1600, the series of instruction operations in the storage medium 1630. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules.

The server 1600 may further include one or more power supplies 1626, one or more wired or wireless network interfaces 1650, one or more input/output interfaces 1658, and/or one or more operating systems, such as Windows Server™, Mac OS X™, Unix™, Linux™, and FreeBSD™.

The steps performed by the server in the above embodiment may be based on a server structure shown in FIG. 17.

The CPU 1622 is configured to perform the following steps:
obtaining a target image; the target image including the face of a target object;
constructing, according to the target image, a three-dimensional facial mesh corresponding to the target object;
transforming the three-dimensional facial mesh into a target UV map, the target UV map being used for carrying position data of various vertices on the three-dimensional facial mesh;
determining target face creation parameters according to the target UV map; and
generating, on the basis of the target face creation parameters, a target virtual facial image corresponding to the target object.

In some embodiments, the CPU 1622 is further configured to execute the steps of any implementation of the image processing method provided in the embodiments of this application.

In some embodiments, the CPU 1622 is further configured to execute the following steps:
obtaining a training image, the training image including the face of a training object;
determining, according to the training image, predicted three-dimensional face reconstruction parameters corresponding to the training object by using a to-be-trained initial three-dimensional face reconstruction model; and constructing, according to the predicted corresponding to the training object;
generating a predicted composite image through a differentiable renderer according to the predicted three-dimensional facial mesh;
constructing a first target loss function according to a difference between the training image and the predicted composite image; training the initial three-dimensional face reconstruction model on the basis of the first target loss function; and
determining the initial three-dimensional face reconstruction model as a three-dimensional face reconstruction model when the initial three-dimensional face reconstruction model satisfies a first training end condition, the three-dimensional face reconstruction model being used for determining three-dimensional face reconstruction parameters corresponding to the target object according to the target image including the face of the target object, and constructing the three-dimensional facial mesh on the basis of the three-dimensional face reconstruction parameters.

In some embodiments, the CPU 1622 is further configured to execute the steps of any implementation of the model training method provided in the embodiments of this application.

The embodiments of this application further provide a computer-readable storage medium, configured to store a computer program. The computer program is used for executing any implementation of the image processing method in the various foregoing embodiments, or used for executing any implementation of the model training method in the various foregoing embodiments.

The embodiments of this application further provide a computer program product or a computer program, the computer program product or the computer program including computer instructions stored in a computer-readable storage medium. A processor of a computer device reads the computer instructions from the computer-readable storage medium and executes the computer instructions, causing the computer device to execute any implementation of the image processing method in the various foregoing embodiments, or to execute any implementation of the model training method in the various foregoing embodiments.

A person skilled in the art can clearly understand that for convenience and conciseness of description, for specific working processes of the foregoing systems, devices, and units, refer to the corresponding processes in the foregoing method embodiments, and details are not described here again.

In the several embodiments provided in this application, it is understood that the disclosed system, apparatuses, and methods may be implemented in other manners. For example, the above described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units are integrated into one unit. The integrated unit may be implemented in a form of hardware, or may be implemented in a form of a software function unit.

When the foregoing integrated unit is implemented in the form of a software functional unit and sold or used as an independent product, the integrated unit may be stored in a computer-readable storage medium. Based on such an understanding, the technical solutions of this application essentially, or the part contributing to the related technology, or all or some of the technical solutions may be implemented in the form of a software product. The computer software product is stored in a storage medium and includes several instructions for instructing a computer device (which may be a personal computer, a server, a network device, or the like) to execute all or some of the steps of the methods described in the various embodiments of this application. The foregoing storage medium includes any medium that can store computer programs, such as a USB flash drive, a removable hard disk, a read-only memory (ROM), a random access memory (RAM), a magnetic disk, or an optical disc.

The foregoing embodiments are merely used for describing the technical solutions of this application, but are not intended to limit this application. Although this application is described in detail with reference to the foregoing embodiments, it should be appreciated by a person ordinarily skilled in the art that: modifications may still be made to the technical solutions described in the foregoing embodiments, or equivalent replacements may be made to the part of the technical features, as long as such modifications or replacements do not cause the essence of corresponding technical solutions to depart from the spirit and scope of the technical solutions of the various embodiments of this application.

What is claimed is:

1. An image processing method performed by a computer device, the method comprising:
constructing a three-dimensional facial mesh corresponding to a target object according to a target image of the target object;
transforming the three-dimensional facial mesh into a target UV map, the target UV map carrying position data of vertices on the three-dimensional facial mesh;
determining target face creation parameters according to the target UV map; and
generating, on the basis of the target face creation parameters, a target virtual facial image corresponding to the target object.

2. The method according to claim 1, wherein the transforming the three-dimensional facial mesh into a target UV map comprises:
determining color channel values of pixel points in the basic UV map on the basis of a correspondence relationship between the vertices on the three-dimensional facial mesh and pixel points in a basic UV map and the position data of the vertices on the three-dimensional facial mesh; and
determining the target UV map on the basis of the color channel values of the pixel points in the basic UV map.

3. The method according to claim 2, wherein the determining color channel values of pixel points in the basic UV map on the basis of a correspondence relationship between the vertices on the three-dimensional facial mesh and pixel points in a basic UV map and the position data of the vertices on the three-dimensional facial mesh comprises:
for each patch on the three-dimensional facial mesh, determining, on the basis of the correspondence relationship, pixel points separately corresponding to the vertices in the patch from the basic UV map, and determining a color channel value of the corresponding pixel point according to the position data of each vertex;
determining a coverage region of the patch in the basic UV map according to the pixel points separately corresponding to the vertices in the patch, and rasterizing the coverage region; and
interpolating, on the basis of a quantity of pixel points comprised in the rasterized coverage region, the color channel values of the pixel points separately corresponding to the vertices in the patch, and taking the interpolated color channel values as color channel values of the pixel points in the rasterized coverage region.

4. The method according to claim 2, wherein the determining the target UV map on the basis of the color channel values of the pixel points in the basic UV map comprises:
determining a reference UV map on the basis of the color channel values of the respective pixel points in a target mapping region in the basic UV map, the target mapping region comprising coverage regions, in the basic UV map, of various patches on the three-dimensional facial mesh; and
mending the reference UV map when the target mapping region not completely covering the basic UV map, to obtain the target UV map.

5. A computer device, comprising a processor and a memory,
the memory being configured to store a computer program; and
the processor being configured to implement an image processing method by executing the computer program, the method including:
constructing a three-dimensional facial mesh corresponding to a target object according to a target image of the target object;
transforming the three-dimensional facial mesh into a target UV map, the target UV map carrying position data of vertices on the three-dimensional facial mesh;
determining target face creation parameters according to the target UV map; and
generating, on the basis of the target face creation parameters, a target virtual facial image corresponding to the target object.

6. The computer device according to claim 5, wherein the transforming the three-dimensional facial mesh into a target UV map comprises:
determining color channel values of pixel points in the basic UV map on the basis of a correspondence relationship between the vertices on the three-dimensional facial mesh and pixel points in a basic UV map and the position data of the vertices on the three-dimensional facial mesh; and
determining the target UV map on the basis of the color channel values of the pixel points in the basic UV map.

7. The computer device according to claim 6, wherein the determining color channel values of pixel points in the basic UV map on the basis of a correspondence relationship between the vertices on the three-dimensional facial mesh and pixel points in a basic UV map and the position data of the vertices on the three-dimensional facial mesh comprises:
for each patch on the three-dimensional facial mesh, determining, on the basis of the correspondence relationship, pixel points separately corresponding to the vertices in the patch from the basic UV map, and determining a color channel value of the corresponding pixel point according to the position data of each vertex;
determining a coverage region of the patch in the basic UV map according to the pixel points separately corresponding to the vertices in the patch, and rasterizing the coverage region; and
interpolating, on the basis of a quantity of pixel points comprised in the rasterized coverage region, the color channel values of the pixel points separately corresponding to the vertices in the patch, and taking the interpolated color channel values as color channel values of the pixel points in the rasterized coverage region.

8. The computer device according to claim 6, wherein the determining the target UV map on the basis of the color channel values of the pixel points in the basic UV map comprises:
determining a reference UV map on the basis of the color channel values of the respective pixel points in a target mapping region in the basic UV map, the target mapping region comprising coverage regions, in the basic UV map, of various patches on the three-dimensional facial mesh; and
mending the reference UV map when the target mapping region not completely covering the basic UV map, to obtain the target UV map.

9. A non-transitory computer-readable storage medium, configured to store a computer program, the computer program, when executed by a processor of a computer device, causing the computer device to implement an image processing method including:
constructing a three-dimensional facial mesh corresponding to a target object according to a target image of the target object;
transforming the three-dimensional facial mesh into a target UV map, the target UV map carrying position data of vertices on the three-dimensional facial mesh;
determining target face creation parameters according to the target UV map; and
generating, on the basis of the target face creation parameters, a target virtual facial image corresponding to the target object.

10. The non-transitory computer-readable storage medium according to claim 9, wherein the transforming the three-dimensional facial mesh into a target UV map comprises:
determining color channel values of pixel points in the basic UV map on the basis of a correspondence relationship between the vertices on the three-dimensional facial mesh and pixel points in a basic UV map and the position data of the vertices on the three-dimensional facial mesh; and
determining the target UV map on the basis of the color channel values of the pixel points in the basic UV map.

11. The non-transitory computer-readable storage medium according to claim 10, wherein the determining color channel values of pixel points in the basic UV map on the basis of a correspondence relationship between the vertices on the three-dimensional facial mesh and pixel points in a basic UV map and the position data of the vertices on the three-dimensional facial mesh comprises:
for each patch on the three-dimensional facial mesh, determining, on the basis of the correspondence relationship, pixel points separately corresponding to the vertices in the patch from the basic UV map, and determining a color channel value of the corresponding pixel point according to the position data of each vertex;
determining a coverage region of the patch in the basic UV map according to the pixel points separately corresponding to the vertices in the patch, and rasterizing the coverage region; and
interpolating, on the basis of a quantity of pixel points comprised in the rasterized coverage region, the color channel values of the pixel points separately corresponding to the vertices in the patch, and taking the interpolated color channel values as color channel values of the pixel points in the rasterized coverage region.

12. The non-transitory computer-readable storage medium according to claim 10, wherein the determining the target UV map on the basis of the color channel values of the pixel points in the basic UV map comprises:
determining a reference UV map on the basis of the color channel values of the respective pixel points in a target mapping region in the basic UV map, the target mapping region comprising coverage regions, in the basic UV map, of various patches on the three-dimensional facial mesh; and
mending the reference UV map when the target mapping region not completely covering the basic UV map, to obtain the target UV map.
